(19) United States
(12) Patent Application Publication
(10) Pub. No.: US 2007/0233700 A1
(43) Pub. Date: Oct. 4, 2007

(54) Storage cluster system, data processing method, and program

(76) Inventor: Kazusa Tomonaga, Fuchu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/723,670

(22) Filed: Mar. 21, 2007

(30) Foreign Application Priority Data
Mar. 30, 2006 (JP) 2006-094721

(51) Int. Cl. G06F 17/30

(52) U.S. Cl. 707/10

(57) ABSTRACT

Disclosed is a storage cluster system which includes a storage cluster constituted of a plurality of storage devices and a host device connected to the storage cluster by a first communication network, and each storage device includes a plurality of accessible regions into which a region logically accessible by the host device is divided, a controller to access to physically accessible regions of the plurality of accessible regions which are physically managed by the storage device, and priority order information which is referred to by the controller and which defines an access priority order of the storage device including the controller to the other storage devices.

### CROSS-REFERENCE TO RELATED APPLICATIONS

This application is based upon and claims the benefit of priority from prior Japanese Patent Application No. 2006-094721, filed Mar. 30, 2006, the entire contents of which are incorporated herein by reference.

### BACKGROUND OF THE INVENTION

1. Field of the Invention

The present invention relates to a storage cluster system in which a plurality of storage devices are connected to each other over a network so that a host device can access the same logical volume via the plurality of storage devices, a data processing method in the storage cluster system, and a program which realizes the data processing method.

2. Description of the Related Art

Conventionally, in a storage cluster system which includes a storage cluster constituted of a plurality of storage devices and a host device connected to the storage cluster via a communication network, there is fixed a correspondence relation between such a logical volume in the storage device to be accessed by the host device and a physical storage medium configured by at least one HDD, etc. that constitutes the logical volume. Therefore, the correspondence relation cannot be changed in a condition where data is being held, so that, for example, there occurs such a situation that access may intensively be made to one physical device and the access is scarcely made to the other physical devices. In consequence, there may occur the situation that a storage device such as the HDD in the storage cluster system cannot be effectively utilized.

In particular, recently, with the expansion in the scale of disk array subsystems and increase in storage capacity of standalone HDDs, the above access deviation has more often occurred, and this trend is increasing. Under such circumstances, demands for a technology which virtualizes the disk array subsystem have been rising, with systems such as described in, for example, http://www.linux.or.jp/JF/JFdocs/LVM-HOWTO-3.html, being put to practical use. In the above technology, a physical storage resource in the disk array subsystem is delimited into regions (extents) each having a constant size, and a correspondence relation between at least one combination of the extents and the logical volume is dynamically managed. Then, data is copied between the extents, thereby enabling the change of a physically existent position of the data (which is referred to as “extent migration”), while the data is held.

Also in such a virtualized disk array subsystem, when the host device gains access, it is necessary to use both a logical unit number (LUN) and a logical block address (LBA), which are based on conventional SCSI specifications. The disk array subsystem writes data from the host device at a position of the physical medium indicated by a combination of the specified LUN and LBA, or transmits (reads) the data to the host device. A portion of each of the logical volumes of extent size units into which a logical volume is delimited in accordance with an extent size is referred to as a logical extent. Here, it is necessary to hold a table (hereinafter referred to as “logical-physical extent mapping table”) which indicates a correspondence relation between the logical extent and an actual storage region (hereinafter referred to as “physical extent”).

However, in the case of a storage cluster system (hereinafter referred to as “virtualized storage cluster system”) which is scalable in capacity and performance so that the above plurality of virtualized disk array subsystems can be connected to each other with a network and an arbitrary disk array device connected with the network can gain access to an arbitrary physical extent, the above logical-physical extent mapping table needs to be held also for the other disk array devices connected with the network, for the purpose of transfer by routing. Routing information for the other devices increases in proportion to the number of the devices which are included in the storage cluster, which leads to a problem that a configuration change at the time of the extent migration may affect the entire storage cluster with an increase in a table search time and an increase in a storage region for table holding.

### BRIEF SUMMARY OF THE INVENTION

In view of the above circumstances, the present invention has been developed, and it is an object of the present invention to provide a storage cluster system, a data processing method, and a program that can avoid an increase in routing information in proportion to the number of storage devices which are included in a storage cluster, can suppress an increase in a table search time and an increase in a storage region for table holding, and can automatically change a configuration at the time of extent migration if necessary, thereby realizing efficient routing.

To achieve the object, the present invention takes the following steps.

That is, a first aspect of the present invention is directed to a data processing method which is applied to a storage cluster system which includes a storage cluster constituted of a plurality of storage devices, and a host device connected to the storage cluster by a first communication network; a storage cluster system which applies the data processing method; and a program which realizes the data processing method.

Here, each storage device includes a plurality of accessible regions into which a region logically accessible by the host device is divided, a controller to access to physically accessible regions of the plurality of accessible regions which are physically managed by the storage device, and priority order information which is referred to by the controller and which defines an access priority order of the storage device including the controller to the other storage devices.

Furthermore, the controllers in the respective storage devices are connected to each other by a second communication network, whereby each of the storage devices can access to the physically accessible region in any of the other storage devices via the controller.

When a processing request for the physically accessible region not present in the storage device is sent from the host device, the controller in the storage device sends the processing request to the controller in the other storage device of the highest priority order except the storage device to which the processing request has already been sent, in accordance with the priority order defined in the priority order information, and when a processing request for the physically accessible region present in the storage device is sent from the host device, the controller in the storage device performs the processing in response to the processing request and sends a result of the processing to a delivery source of the processing request, and when the processing result is sent from the controller in the other storage device to the storage device, the controller in the storage device sends the processing result to the delivery source which has sent the processing request corresponding to the processing result to the storage device, the processing result is sent to the storage device which has received the processing request from the host device, and this storage device sends the received processing result to the host device.

A second aspect of the present invention is directed to a data processing method which is applied to a storage cluster system which includes a storage cluster constituted of a plurality of storage devices, and a host device connected to the storage cluster by a first communication network; a storage cluster system which applies the data processing method; and a program which realizes the data processing method.

Here, each storage device includes a plurality of accessible regions into which a region logically accessible by the host device is divided, a controller to access to a physically accessible region of the plurality of accessible regions which is physically managed by the storage device, and priority order information which is referred to by the controller and which defines an access priority order of the storage device including the controller to the other storage devices.

The controllers in the respective storage devices are connected to each other by a second communication network, whereby each of the storage devices can access to the physically accessible region in any of the other storage devices via the controller.

The storage device which has received from the host device a processing request for the physically accessible region not present in the storage device acquires from the processing request a unique specific command corresponding to the processing request, introduces bit map data including an identifier of the storage device and an identifier of the host device into the command code, sets a bit at a bit position corresponding to the identifier of the storage device in bit map data, and sends the command code to any of the other storage devices of the highest priority order except the storage device to which the processing request has already been sent, in accordance with the priority order information; in a case where, in the storage device to which the command code is sent from any of the plurality of storage devices, the processing request corresponding to the command code is a processing request for the physically accessible region not present in the storage device, the storage device sets a bit at a bit position corresponding to the identifier in the bit map data included in the command code, and sends the command code to the storage device of the highest priority order except the storage device to which the processing request has already been sent, in accordance with the priority order information; in a case where the processing request corresponding to the sent command code is a processing request for the physically accessible region present in the storage device and in a case where the bit map data is not included in the sent command code, this storage device performs the processing in response to the processing request corresponding to the command code and sends a result of the processing to the host device; in a case where the bit map data is included in the sent command code and a bit is set at any one of the bit positions, this storage device performs the processing in response to the processing request corresponding to the command code, and sends a result of the processing to the storage device having the identifier corresponding to the bit position where the bit is set; in a case where the bit map data is included in the sent command code and the bits are set at a plurality of bit positions, this storage device performs the processing in response to the processing request corresponding to the command code, creates a response for the storage device which has received the processing request directly from the host device, and sends the created response to the storage device which has received the processing request from the host device via the storage device having the identifier corresponding to the bit position where the bit is set; the storage device to which the response is sent requests the storage device which has created the response to send the processing result; the requested storage device sends the processing result to the storage device of a request source, so that the processing result obtained in any one of the storage devices is sent to the storage device which has received the processing request directly from the host device. Then, the storage device which has received the processing request directly from the host device sends the processing result to the host device.

A third aspect of the present invention is directed to the storage cluster system according to the first or second aspect, wherein, in a case where the processing request is sent to the controller in the other storage device in accordance with the priority order defined in the priority order information and in a case where the controller of a destination does not accept the processing request and in a case where an error response is returned from the controller or in a case where the controller gives no response for a predetermined lapse of time, the processing request is sent to the controller in the storage device of the next highest priority order except the storage device to which the processing request has already been sent.

A fourth aspect of the present invention is directed to the storage cluster system according to the first or second aspect, wherein the storage device of the plurality of storage devices to which the host device has accessed is equipped with a notification part which notifies the host device of information of a physically accessible region held in each of the storage devices, and the host device is equipped with a switch part which switches the storage device to which the processing request is to be sent, on the basis of the information notified from the notification part and contents of the processing request.

A fifth aspect of the present invention is directed to the storage cluster system according to the first or second aspect, wherein every storage device in the storage cluster includes a data table which manages a combination of capacity information of a logical volume which is constituted of one or a combination of two or more of the plurality of accessible regions included in each storage device and which is recognized by the host device, a host identification number which specifies the host device permitted to access to the logical volume, and a physically accessible region identification number to specify a physically accessible region to which the host device accesses. The storage device only in which the physically accessible region is present holds a correspondence relation between the physically accessible region and the logically accessible region which is recognized by the host device, among the accessible regions which constitute the logical volume; and the storage device to which the host device has accessed sends the processing result to the host device, in response to a processing request other than media access commands including write and read commands, among the processing requests sent from the host device.

A sixth aspect of the present invention is directed to the storage cluster system according to the first or second aspect, which further includes a management console which manages the storage cluster. The management console sends information of the storage devices and a construction request of the storage cluster to an arbitrary one of the storage devices, and the storage device of the destination is defined as a construction master which plays a role of a master of construct processing of the storage cluster. The construction master transmits a test message to each storage device corresponding to the information sent from the management console; each storage device which has received the test massage returns a response to the test message to the construction master; the construction master measures response times of the storage devices to the test message based on the responses returned from the storage devices, prioritizes the storage devices from a short side of the response times to thereby create priority order information, and sends a list of the storage devices included in the storage cluster to each of the storage devices; each of the storage devices other than the construction master transmit the test message to the storage devices other than the storage device in accordance with the sent list; each storage device which has received the test message returns a response to the test message to the storage device of the transmission source; the storage devices other than the construction master measure response times of the storage devices to the test message based on the returned responses, prioritizes the storage devices from a short side of the response times to thereby create priority order information, returns a construction completion response for the priority order information to the construction master; and the construction master, when having received the construction completion response, returns the construction completion response for the priority order information to the management console to perform construction processing of the storage cluster.

A seventh aspect of the present invention is directed to the storage cluster system according to the first or second aspect, which further includes a management console which performs processing of addition to add a new storage device to the storage cluster which is operating. The management console transmits a request for addition of the new storage device and information of the new storage device to an arbitrary one of the storage devices, and the storage device of a transmission destination is defined as a master of addition which plays a role of a master of the procedure for addition of the storage device. The master of addition transmits a test message to the new storage device to which the information has been transmitted from the management console, confirms a response sent by the new storage device to the transmitted test message, adds an access priority order of the new storage device to the priority order information as the lowest priority order, and transmits a message about the addition of the new storage device to the storage cluster and the information of the new storage device to the storage devices in which the access priority order has already been defined in the priority order information; the storage devices other than the master of addition and the new storage device add the new storage device to the lowest position in the priority order information of the storage devices, and return an addition completion response to the master of addition; the master of addition transmits a list of the storage devices included in the storage cluster to the new storage device; the new storage device transmits a test message to the storage devices other than the storage device in accordance with the list; the storage devices which have received the test message return a response to the test message to the new storage device; the new storage device measures response times of the storage devices to the test message based on the returned responses, and prioritizes the storage devices from a short side of the response times to thereby create priority order information, and returns a construction completion response for the priority order information to the master of addition; and the master of addition, when having received the construction completion response and the addition completion response, returns an addition completion response for the new storage device to the management console, thereby completing the procedure for addition of the new storage device.

According to the present invention, it is possible to avoid an increase in routing information in proportion to the number of the storage devices included in the storage cluster, which suppresses an increase in a table search time and an increase in a storage region for table holding. In addition, a configuration at the time of migration of the extents can automatically be changed, if necessary. Therefore, the present invention can realize the storage cluster system, the data processing method and the program which permits efficient routing.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration example of a storage cluster system which applies a data processing method according to a first embodiment;

FIG. 2 is a conceptual diagram showing an example of a physical storage medium divided into three extents;

FIG. 3 is a schematic view showing routing of a processing request command in the storage cluster system according to the first embodiment;

FIG. 4 is a flow chart showing an operational example of the storage cluster system according to a second embodiment;

FIG. 5 is a table in which differences among Case 1 to Case 5 in the operation of the storage cluster system according to the second embodiment are summarized;

FIG. 6 is a diagram showing a flow of processing in Case 5 in the operation of the storage cluster system according to the second embodiment;

FIG. 7 is a diagram showing a flow of processing in the operation of the storage cluster system according to a third embodiment;

FIG. 8 is a diagram showing a flow of processing in the operation of the storage cluster system according to a fourth embodiment;

FIG. 9 is a diagram showing a flow of processing in the operation of the storage cluster system according to a fifth embodiment;

FIG. 10 is a block diagram showing a configuration example of the storage cluster system in which a management console is included;

FIG. 11 is a block diagram showing another configuration example of the storage cluster system in which the management console is included;

FIG. 12 is a flow chart showing a flow of prioritized routing table construction processing in the storage cluster system according to a sixth embodiment;

FIG. 13 is a diagram showing a configuration example of the storage cluster system to which a new storage device is added;

FIG. 14 is a flow chart showing a flow of new storage device addition processing in the storage cluster system according to a seventh embodiment;

FIG. 15 is a functional block diagram showing a configuration example of the storage cluster system according to the embodiment;

FIG. 16A is one example of a table showing a correspondence relation between a logical extent and a physical extent;

FIG. 16B is one example of a table showing a correspondence relation between a logical extent and a physical extent;

FIG. 16C is one example of a table showing a correspondence relation between a logical extent and a physical extent;

FIG. 17 is one example of a host device-LUN mapping table showing a relation among an identification number of the host device, a pinpoint value of the host device, a logical extent number, and an LUN number;

FIG. 18A is one example of the prioritized routing table;

FIG. 18B is one example of the prioritized routing table;

FIG. 18C is one example of the prioritized routing table;

FIG. 19A shows a table in which the SCSI commands for read and write are summarized for each device of a transmission source;

FIG. 19B shows a table of one example of a command format;

FIG. 20A shows a table of one example of an extent routing table;

FIG. 20B shows a table of one example of an extent routing table; and

FIG. 20C shows a table of one example of an extent routing table.

### DETAILED DESCRIPTION OF THE INVENTION

The following will describe the best mode for carrying out the present invention with reference to drawings.

### First Embodiment

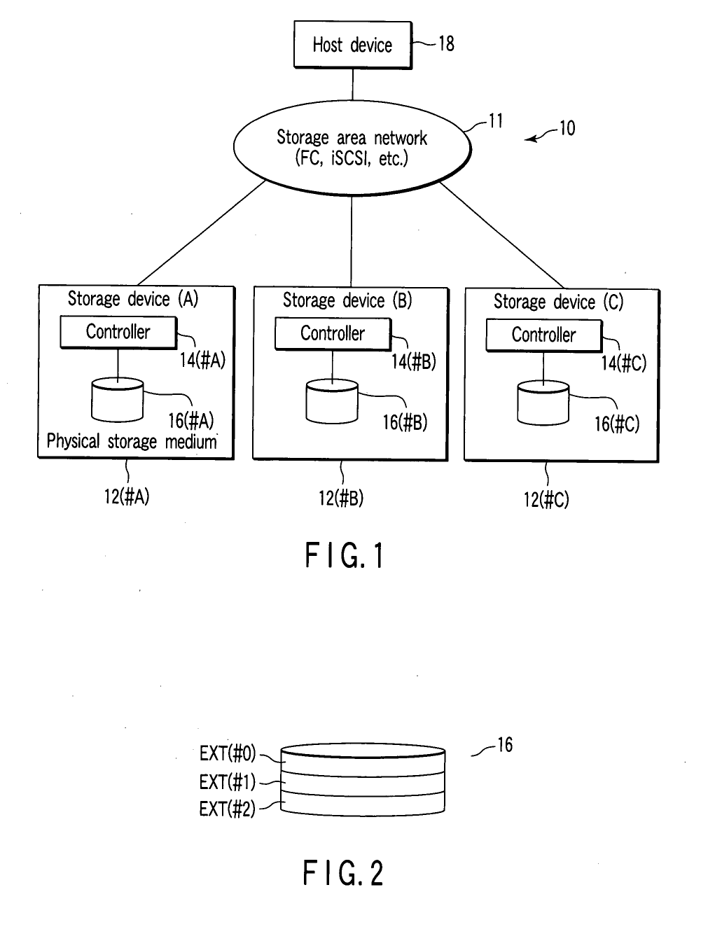

FIG. 1 is a block diagram showing a configuration example of a storage cluster system which applies a data processing method according to the first embodiment of the present invention.

That is, a storage cluster system 10 according to the present embodiment includes a plurality of storage devices 12 (#A, #B, and #C) connected to each other via a storage area network 11 constituted of a fiber channel, an iSCSI or the like and a host device 18 similarly connected to the storage area network 11. The plurality of storage devices 12 (#A, #B, and #C) are collectively referred to also as a storage cluster.

The storage devices 12 each include a controller 14 and a physical storage medium 16 constituted of hardware of a memory, an HDD and the like. Only three storage devices 12 are representatively shown in the drawing, but the number is not limited to three.

The physical storage medium 16 is divided into a plurality of extents EXTs as shown in, for example, FIG. 2. Each extent is a unitary region to which the host device 18 logically sequentially accesses. FIG. 2 shows an example including three extents EXTs (#0, #1, and #2), but the number is not limited to three, needless to say. Furthermore, the extents are classified into a logical extent which is recognized by the host device 18 and a physical extent which is physically managed by the storage device 12.

The controller 14 is provided to allow access to the physical extent. The controller 14 holds a prioritized routing table which defines priority order from one storage device 12, including the controller 14 itself, to the other storage devices 12.

The respective storage devices 12 connect these controllers 14 to each other via the storage area network 11. In consequence, the respective storage devices 12 access to the physical extents of the physical storage media 16 in the other storage devices 12 via the controllers 14.

When a processing request command is sent from the host device 18 to any one of the storage devices 12 which constitute the storage cluster, the controller 14 behaves as follows.

When a processing request command is sent from the host device 18 to, for example, the storage device 12 (#A) and if this processing requests access to the physical extent present in the physical storage medium 16 (#A) in the storage device 12 (#A), the controller 14 (#A) performs the processing in response to the processing request command and then returns a result of the processing to the host device 18 which is a delivery source of the processing request.

On the other hand, when a processing request command is sent from the host device 18 to the storage device 12 (#A) and if this processing requests access to the physical extent not present in the physical storage medium 16 (#A) in the storage device 12 (#A), the controller 14 (#A) transfers the processing request command to the controller 14 in the storage device 12 having the highest priority order and the high priority order next to the above storage device except the upstream storage device, i.e., the storage device to which the processing request command has already been sent, in accordance with the access priority order defined in the prioritized routing table. For example, if the storage device 12 (#B) has the highest priority order in the prioritized routing table and is on the downstream side of the storage device 12 (#A), the controller 14 (#A) in the storage device 12 (#A) transfers the processing request command to the controller 14 (#B).

If the processing request command is sent from the controller 14 (#A) to the controller 14 (#B) in this manner and this processing requests access to the physical extent present in the physical storage medium 16 (#B), the controller 14 (#B) performs the processing in response to the processing request command and returns a result of the processing to the controller 14 (#A) which is a delivery source of the processing request command. After the processing result has been returned from the controller 14 (#B) to the controller 14 (#A) in this manner, the controller 14 (#A) returns the processing result to the host device 18 which is the delivery source of the processing request.

On the other hand, when a processing request command is sent from the controller 14 (#A) to the controller 14 (#B) and if this processing requests access to the physical extent not present in the physical storage medium 16 (B), the controller 14 (#B) transfers the processing request command to the controller 14 in the storage device 12 of the highest priority order except the upstream storage device in accordance with the access priority order defined in the prioritized routing table. For example, if the storage device 12 (#C) has the high priority order next to the storage device 12 (#B) except the upstream storage device, the controller 14 (#B) transfers the processing request command to the controller 14 (#C).

If the processing request command is sent from the controller 14 (#B) to the controller 14 (#C) in this manner and this processing requests access to the physical extent present in the physical storage medium 16 (#C), the controller 14 (#C) performs the processing in response to the processing request command and returns a result of the processing to the controller 14 (#B) which is a delivery source of the processing request command. After the processing result has been returned from the controller 14 (#C) to the controller 14 (#B) in this manner, the controller 14 (#B) returns the processing result to the controller 14 (#A) which is the delivery source of the processing command. Furthermore, after the processing result has been returned from the controller 14 (#B) to the controller 14 (#A) in this manner, the controller 14 (#A) returns the processing result to the host device 18 which is the delivery source of the processing request command.

On the other hand, when a processing request command is sent from the controller 14 (#B) to the controller 14 (#C) and if this processing requests access to the physical extent not present in the physical storage medium 16 (#C), the controller 14 (#C) transfers the processing request command to the controller 14 in the storage device 12 of the highest priority order except the upstream storage device in accordance with the access priority order defined in the prioritized routing table.

In a case where the host device 18 sends a processing request command to any storage device 12 of the storage cluster, the controller 14 in each storage device 12 behaves as described above, so that data transfer such as write and read is performed sequentially between the above storage device 12 and the upstream storage device 12 in turn from a target storage device which is the storage device 12 having the physical extent required for the processing, and finally the result of the processing is returned to the host device 18.

It is to be noted that the storage cluster system 10 constituted as described above is implemented by, for example, reading, into the host device 18 and the storage devices 12, a program recorded in a recording medium such as a magnetic disk [a floppy (registered trademark) disk, a hard disk or the like], an optical disk (a CD-ROM, a DVD or the like) or a semiconductor memory, or a program downloaded via a communication network such as the internet, and then controlling the operation of the host device 18 and the storage devices 12 by the program. Furthermore, the program recorded in the recording medium includes a setting program which introduces, into the host device 18 and the storage devices 12, software means (including not only an execution program but also a table and a data structure) to be executed by a computer. The above program causes the computer to behave as described above, when the above program is read from the recording medium or the communication medium into the computer.

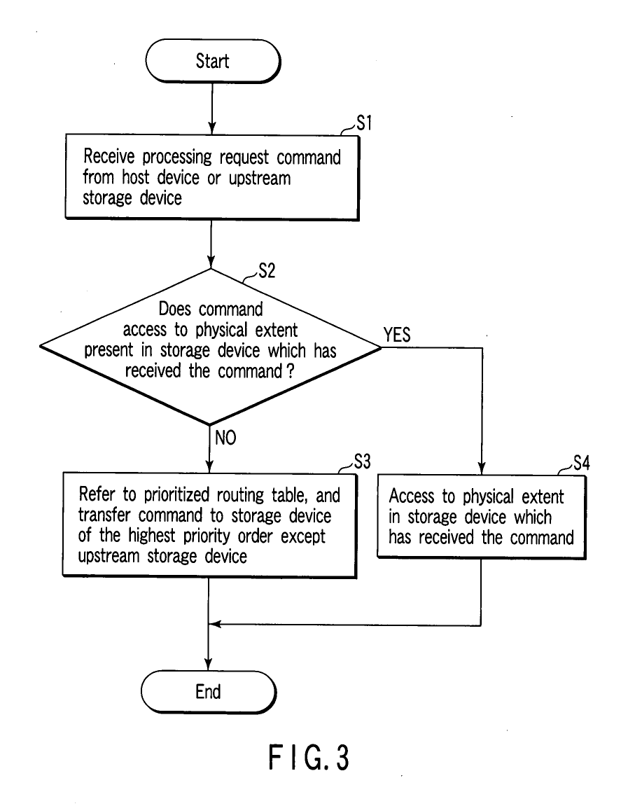

Routing of a processing request command in the storage cluster system according to the present embodiment constituted as described above is simply shown in FIG. 3.

That is, when a request command is sent to the storage device 12 from the host device 18 or the upstream storage device 12 (S1), and if this processing requests access to the physical extent not present in the physical storage medium 16 (NO at S2) thereof, the controller 14 transfers the processing request command to the controller 14 in the storage device 12 of the highest priority order except the upstream storage device in accordance with the access priority order defined in the prioritized routing table (S3).

On the other hand, at a step S2, if this processing requests access to the physical extent present in the physical storage medium 16 (YES at S2), the processing request command accesses to the physical storage medium 16, so that the processing is performed in response to the processing request command (S4).

As described above, in the storage cluster system according to the present embodiment, in a case where the host device 18 sends the processing request command to any one of the storage devices 12 of the storage cluster by such a function as described above, data transfer such as write and read is performed between the above storage device 12 and the upstream storage device 12 in turn from a target storage device which is the storage device 12 having the physical extent required for the processing, and finally the result of the processing is returned to the host device 18.

It is thus possible to avoid an increase in routing information in proportion to the number of the storage devices 12 included in the storage cluster, which suppresses an increase in a table search time and an increase in a storage region for table holding. In addition, a configuration at the time of migration of the extents can be automatically changed, if necessary. As a result, efficient routing can be realized.

### Second Embodiment

The present invention will be described below according to the second embodiment.

A storage cluster system which applies a data processing method according to the second embodiment of the present invention is a modification of the storage cluster system which applies the data processing method according to the first embodiment, and an operation of the controller 14 is the only difference therebetween. In this embodiment, therefore, only the operation of the controller 14 will be described below, with repetitive explanations omitted.

The controller 14 is provided to access to a physical extent. The controller 14 holds a prioritized routing table which defines an access priority order from the storage device 12 including the controller 14 to the other storage devices 12.

The respective storage devices 12 connect these controllers 14 to each other via the storage area network 11. In consequence, the respective storage devices 12 access to the physical extents of the physical storage media 16 in the other storage devices 12 via the controllers 14.

When a processing request command is sent from the host device 18 to any one of the storage devices 12 which constitute the storage cluster, the controller 14 behaves as follows.

When a processing request command is sent from the host device 18 to, for example, the storage device 12 (#A) and if this processing requests access to the physical extent present in the physical storage medium 16 (#A) in the storage device 12 (#A), the controller 14 (#A) performs the processing in response to the processing request command and returns a result of the processing to the host device 18 which is a delivery source of the processing request.

On the other hand, when a processing request command is sent from the host device 18 to the storage device 12 (#A) and if this processing requires access to the physical extent not present in the physical storage medium 16 (#A) in the storage device 12 (#A), the controller 14 (#A) acquires, from the processing request command, a vendor-unique command code which is a unique command corresponding to the processing request command, and introduces bit map data including an identifier of the above storage device 12 (#A) and an identifier of the host device 18 into the vendor-unique command code. Then, the controller 14 (#A) sets a bit at a bit position corresponding to the identifier of the above storage device 12 (#A) in the bit map data, and transfers the vendor-unique command code to the controller 14 in the storage device 12 of the highest priority order, except the upstream storage device, in accordance with the access priority order defined in the prioritized routing table. For example, if the storage device having the highest priority order next to the storage device 12 (#A) except the upstream storage device is the storage device 12 (#B), the controller 14 (#A) transfers the vendor-unique command code to the controller 14 (#B).

When the vendor-unique command code is sent from the controller 14 (#A) to the controller 14 (#B) in this manner and if the corresponding processing requires access to the physical extent present in the physical storage medium 16 (#B), the controller 14 (#B) performs this processing and returns a result of the processing to the controller 14 in the storage device 12 having the identifier corresponding to the bit position where the bit is set in vendor-unique command data, that is, the controller 14 (#A) in the storage device 12 (#A). After the processing result has been returned from the controller 14 (#B) to the controller 14 (#A) in this manner, the controller 14 (#A) returns the processing result to the host device 18 which is the delivery source of the processing request command.

On the other hand, when a vendor-unique command code is sent from the controller 14 (#A) to the controller 14 (#B), and if processing corresponding to the vendor-unique command code requires access to the physical extent not present in the physical storage medium 16 (#B), the controller 14 (#B) sets a bit at a bit position corresponding to its identifier in bit map data included in the vendor-unique command code and transfers the vendor-unique command code to the controller 14 in the storage device 12 of the highest priority order except the upstream storage device in accordance with the access priority order defined in the prioritized routing table. For example, if the storage device having the high priority order next to the storage device 12 (#B) except the upstream storage device is the storage device 12 (#C), the control 14 (#B) transfers the vendor-unique command code to the controller 14 (#C).

When a vendor-unique command code is sent from the controller 14 (#B) to the controller 14 (#C) in this manner, and if the corresponding processing requires access to the physical extent present in the physical storage medium 16 (#C), the controller 14 (#C) performs the corresponding processing, creates a response to the storage device 12 (#A) as a storage device which has received the processing request directly from the host device 18, and sends the created response to the storage device 12 (#A) via the storage device 12 (#B) as a storage device having the identifier corresponding to the bit position where the bit is set.

After the controller 14 (#A) has received the response, the storage device 12 (#A) requests the controller 14 (#C) in the storage device 12 (#C) to send a result of the processing.

Then, in response to the request, the controller 14 (#C) sends the processing result to the controller 14 (#A) in the storage device 12 (#A). After having received the processing result, the controller 14 (#A) sends it to the host device 18.

The processing result performed in any of the storage devices (#A, #B, and #C) in this manner is sent to the host device 18 via the storage device 12 (#A) which has received a processing request directly from the host device 18. However, as explained with reference to an example of the storage device 12 (#C), in a case where the storage device 12 (#B) which does not perform the processing is present between the storage device 12 (#A) which has received the processing request directly from the host device 18 and the storage device 12 (#C) which performs the processing (here, the storage device 12 (#B) is defined as “the intermediate storage device”), a result of the processing performed in the storage device 12 (#C) is directly sent to the storage device 12 (#A) without passing through the storage device 12 (#B). In consequence, the data is efficiently transmitted through a shortest path.

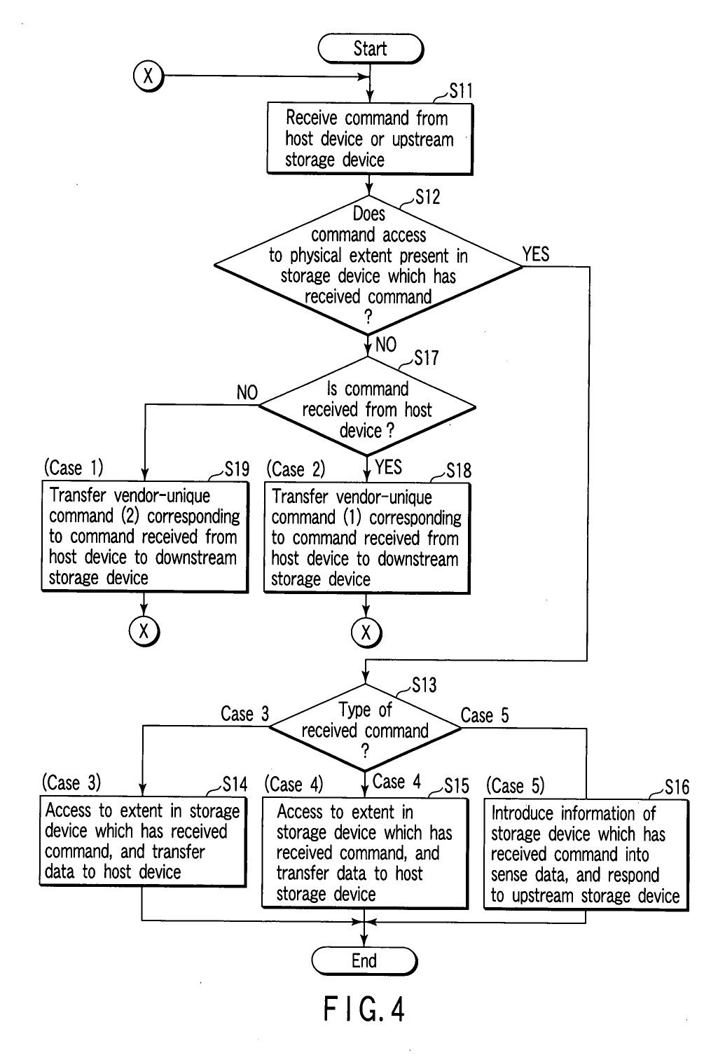

Next, an operational example of the storage cluster system according to the present embodiment constituted above will be described with reference to a flow chart shown in FIG. 4.

When a processing request command is sent from the host device 18 to the storage device 12 (#A) (S11) and if this processing requires access to the physical extent present in the physical storage medium 16 (#A) in the storage device 12 (#A) (YES at S12, Case 3 at S13), the controller 14 (#A) performs the processing in response to the processing request command and returns a result of the processing to the host device 18 which is a delivery source of the processing source (S14).

On the other hand, if this processing requires access to the physical extent not present in the physical storage medium 16 (#A) in the storage device 12 (#A) (NO at S12, YES (Case 2) at S17), the controller 14 (#A) acquires from the processing request command a vendor-unique command code which is a unique command corresponding to the processing request command, and introduces bit map data including an identifier of the storage device 12 (#A) and an identifier of the host device 18 into the vendor-unique command code. Then, in the bit map data, the controller 14 (#A) sets a bit at a bit position corresponding to the identifier of the storage device 12 (#A), and transfers the vendor-unique command code to the controller 14 (#B) in the storage device 12 (#B) of the highest priority order, except the upstream storage device, in accordance with the access priority order defined in the prioritized routing table (S18).

When a vendor-unique command code is sent from the controller 14 (#A) to the controller 14 (#B) in this manner (S11) and if the corresponding processing requires access to the physical extent present in the physical storage medium 16 (#B) (YES at S12, Case 4 at S13), the controller 14 (#B) performs this processing and returns a result of the processing to the controller 14 in the storage device 12 having the identifier corresponding to the bit position where the bit is set in vendor-unique command data, that is, the controller 14 (#A) in the storage device 12 (#A) (S15). After the processing result has been returned from the controller 14 (#B) to the controller 14 (#A) in this manner, the controller 14 (#A) returns the processing result to the host device 18 which is a delivery source of the processing request command.

On the other hand, when a vendor-unique command code is sent from the controller 14 (#A) to the controller 14 (#B) and if processing corresponding to this vendor-unique command code requires access to the physical extent not present in the physical storage medium 16 (#B) (NO (Case 1) at S17), the controller 14 (#B) sets a bit at a bit position corresponding to its identifier in bit map data included in this vendor-unique command code, and transfers the vendor-unique command code to the controller 14 in the storage device 12 of the highest priority order except the upstream storage device in accordance with the access priority order defined in the prioritized routing table. For example, if the storage device having the highest priority order next to the storage device 12 (#B) except the upstream storage device is the storage device 12 (#C), the control 14 (#B) transfers the vendor-unique command code to the controller 14 (#C) (S19).

When a vendor-unique command code is sent from the controller 14 (#B) to the controller 14 (#C) in this manner (S11) and if the corresponding processing requires access to the physical extent present in the physical storage medium 16 (#C) (YES at S12, Case 5 at S13), the controller 14 (#C) performs the corresponding processing and creates sense data which is a response to the storage device 12 (#A) as the storage device which has received the processing request directly from the host device 18, and sends the created sense data via the storage device 12 (#B) to the storage device 12 (#A) (S16). After the controller 14 (#A) in the storage device 12 (#A) has received the sense data, the controller 14 (#A) requests the controller 14 (#C) to send a result of the processing. Then, in response to the request, the controller 14 (#C) sends the processing result to the controller 14 (#A) in the storage device 12 (#A). When having received the processing result, the controller 14 (#A) sends it to the host device 18.

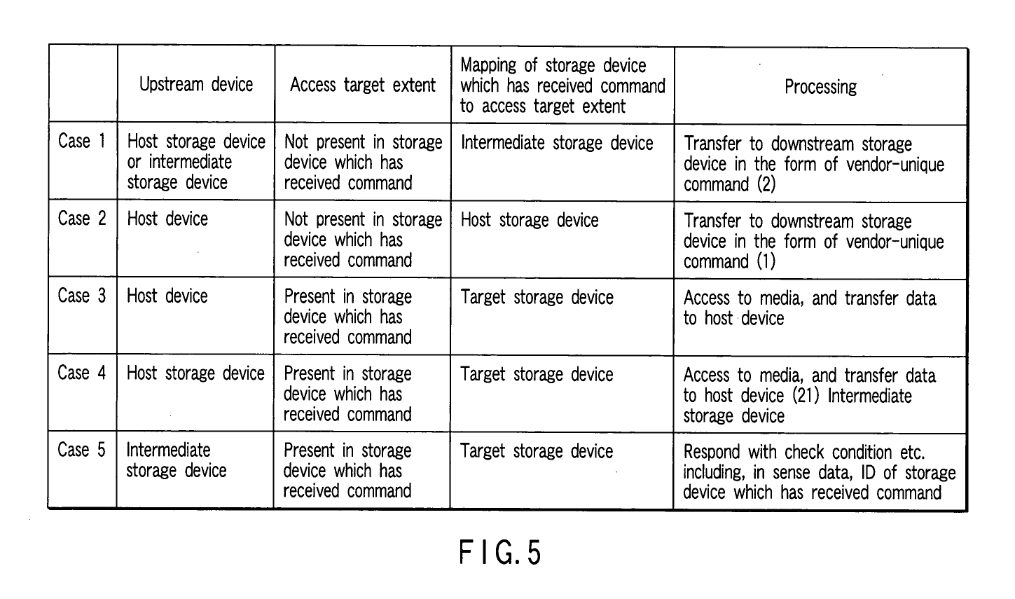

FIG. 5 is a table in which differences among the above-described Case 1 to Case 5 are summarized. In FIG. 5, a host storage device corresponds to the storage device 12 (#A), an intermediate storage device corresponds to the storage device 12 (#B), and a target storage device corresponds to the storage device 12 (#C).

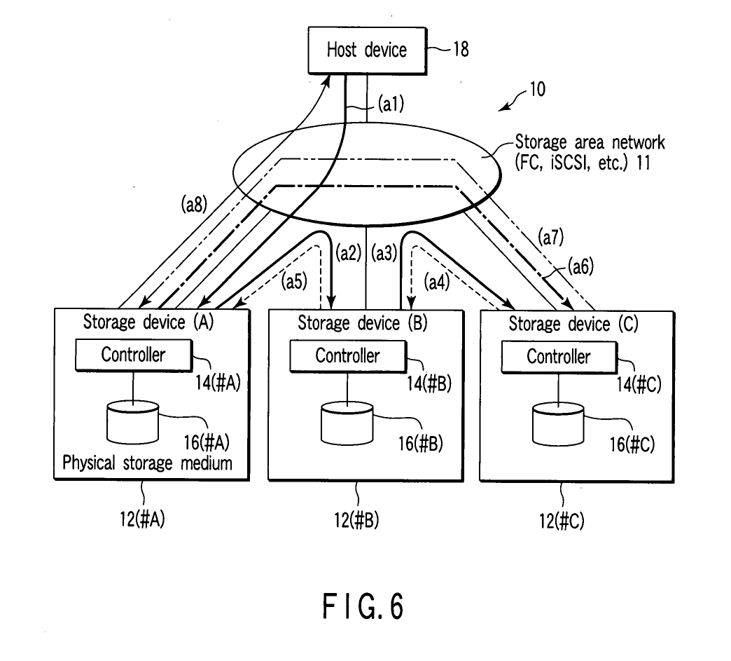

FIG. 6 is a diagram showing a flow of processing in the above Case 5. That is, a processing request command is sent from the host device 18 to the storage device 12 (#A) (a1). However, this processing requires access to the physical extent present in the physical storage medium 16 (#C), so that the controller 14 (#A) creates a vendor-unique command code including bit map data in which a bit corresponding to the storage device 12 (#A) is set, and transfers the created vendor-unique command code to the controller 14 (#B) (a2). Furthermore, the controller 14 (#B) sets a bit corresponding to the storage device 12 (#B) and transfers the vendor-unique command code to the controller 14 (#C) (a3).

Then, the controller 14 (#C) performs the processing corresponding to the vector-unique command code, creates sense data which is a response to the storage device 12 (#A), and sends the created sense data via the storage device 12 (#B) (a4) to the storage device 12 (#A) (a5).

After the storage device 12 (#A) has received the sense data, the controller 14 (#A) requests the controller 14 (#C) to send a result of the processing (a6), so that in response to this request, the controller 14 (#C) sends the processing result to the controller 14 (#A) in the storage device 12 (#A) (a7). After having received this processing result, the controller 14 (#A) sends it to the host device 18 (a8).

As described above, in the storage cluster system according to the present embodiment, a result of the processing which has been performed in any of the storage devices (#A, #B, and #C) is returned to the host device 18 via the storage device 12 (#A) which has received the processing request directly from the host device 18. In this case, as in the case that the processing is done in the storage device 12 (#C), if the storage device 12 (#B) which does not perform the processing is interposed between the storage device 12 (#A) which has received the processing request directly from the host device 18 and the storage device 12 (#C) which performs the processing, a result of the processing performed in the storage device 12 (#C) can be directly sent to the storage device 12 (#A) without passing through the storage device 12 (#B). In consequence, even in a case where the processing is not performed in the storage device 12 which has received the processing request from the host device 18, data which is the processing result can be transmitted efficiently through a shortest path.

### Third Embodiment

The present invention is described below with reference to the third embodiment.

A storage cluster system which applies a data processing method according to the third embodiment of the present invention is a modification of the storage cluster system which applies the data processing method according to the first or second embodiment, and an operation of the controller 14 is the only difference therebetween. Therefore, only the operation of the controller 14 will be described below, with repetitive explanations omitted.

That is, in the storage cluster system according to the present embodiment, in a case where a processing request is sent to the controller 14 in any other storage device 12 except the upstream storage device 12 in accordance with priority order defined in a prioritized routing table, and if the processing request is not accepted by the controller 14 in the destination storage device 12 owing to its fault or the like (transfer is impossible), if an error response is sent from the destination controller 14, or if the processing becomes time-out because no response is sent from the destination controller for a predetermined lapse of time, the processing request is sent again to the controller in the storage device having the next highest priority order except the upstream storage devices 12.

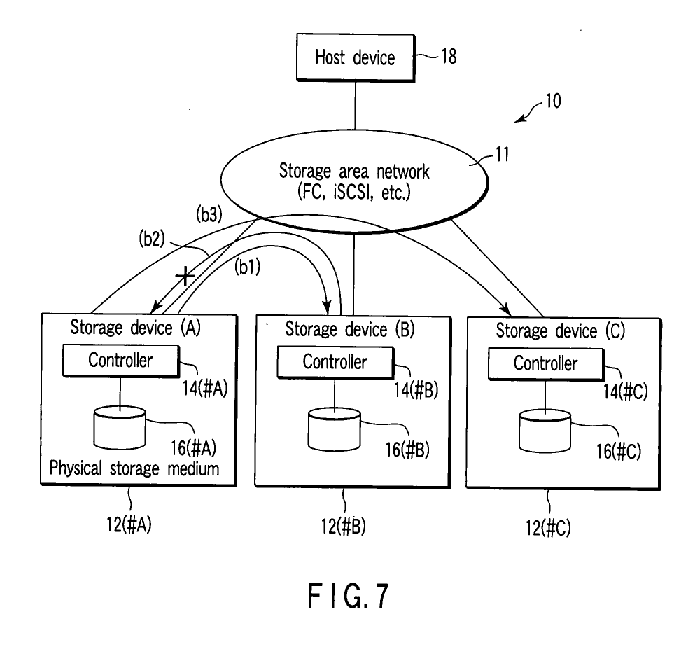

For example, as shown in FIG. 7, a processing request given from the host device 18 is sent from the controller 14 (#A) in the storage device 12 (#A) to the controller 14 (#B) in the storage device 12 (#B) in accordance with the priority order defined in the prioritized routing table. In this case, if the storage device 12 (#B) is normally operating, a processing result or sense data ought to be returned from the controller 14 (#B) to the controller 14 (#A) in the storage device 12 (#A). However, if the storage device 12 (#B) does not operate normally owing to a fault or the like, the controller 14 (#B) does not accept the processing request (transfer is impossible), an error response is sent from the controller 14 (#B) or no response is sent from the controller (#B) for a predetermined lapse of time so that the controller 14 (#A) decides that it has timed-out (b2).

In this case, the controller 14 (#A) sends again the processing request sent to the controller 14 (#B) to the controller 14 (#C) (b3).

In this way, the processing request is sent to the other storage device 12 by passing the storage device 12 not operating normally, whereby it is possible to continue the processing without interrupting it.

### Fourth Embodiment

The present invention is described below with reference to the third embodiment.

A storage cluster system which applies a data processing method according to the fourth embodiment of the present invention is a modification of a storage cluster system which applies the data processing method according to the first or second embodiment. In the modification, there are added the following notification function to the controller 14 and the following switch function to the host device 18, respectively, in addition to the functions described in the first and second embodiments. Therefore, only the differences will be described below, with repetitive explanations omitted.

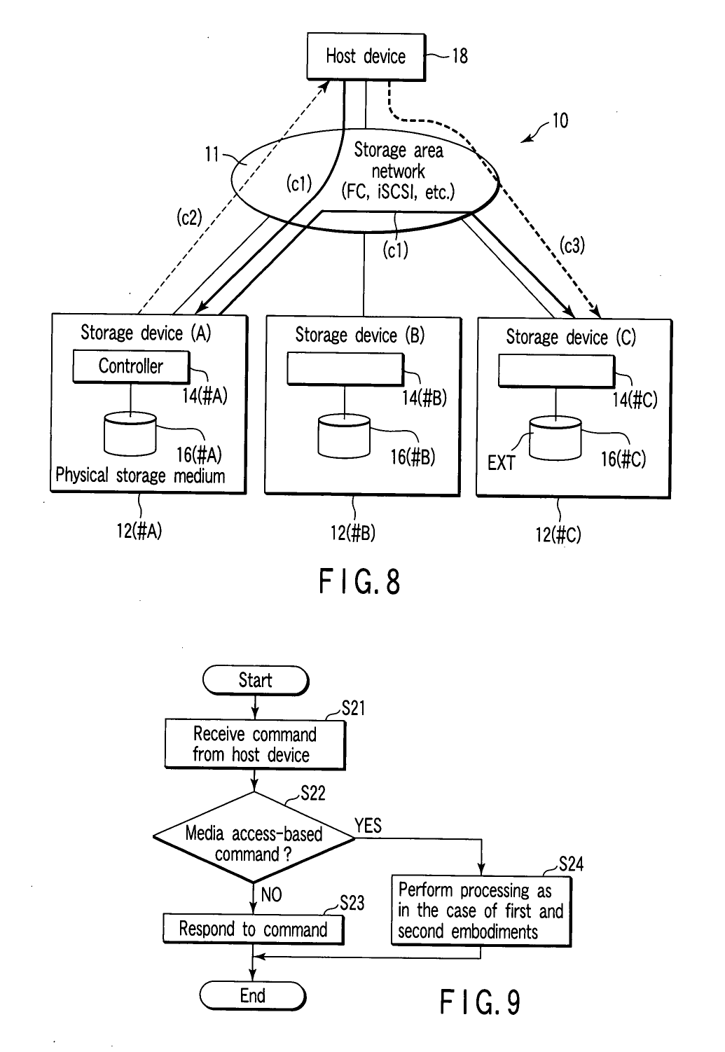

That is, in the present embodiment, as shown in FIG. 8, of the storage devices 12 (#A, #B, and #C), the storage device 12 (#A) to which the host device 18 accesses has a function to notify the host device 18 of information of physical extents held by the storage devices 12 (#A, #B, and #C) synchronously or asynchronously, for example, every constant period.

Furthermore, the host device 18 is equipped with a function to switch the storage device 12 to which a processing request is to be sent, on the basis of on the information notified of by the notification function of the storage device 12 (#A) and contents of a processing request.

In the above configuration of the storage cluster system according to the present embodiment, the storage device 12 (#A) notifies the host device 18 which ought to access to the storage device 12 (#C) via the storage device 12 (#A) (c1) of information of the physical extents held in the storage devices 12 (#A, #B, and #C) (c2).

Therefore, the host device 18 understands that the physical extent corresponding to the processing request is present in the storage device 12 (#C), so that the storage device 12 to which the processing request is sent is switched from the storage device 12 (#A) to the storage device 12 (#C) (c3).

In consequence, it is possible to minimize a path for the processing request from the host device 18 and a path through which a processing result of the processing request is returned to the host device 18, thereby enabling the realization of efficient transmission.

### Fifth Embodiment

The present invention is described below with reference to the fifth embodiment.

A storage cluster system which applies a data processing method according to the fifth embodiment of the present invention is a modification of the storage cluster system which applies the data processing method according to the first or second embodiment. To the storage device 12, there are added the following new functions, in addition to the described in the first and second embodiments. In this embodiment, therefore, only the differences will be described below, with repetitive explanations omitted.

That is, in the storage cluster system according to the present embodiment, each storage device 12 holds a management data table. The management data table can be recognized by a host device 18, and manages a combination of capacity information of a logical volume constituted of extents, a host identification number for specifying the host device 18 permitted to access to the logical volume, and a physically accessible region identification number for specifying a physical extent to which the host device 18 accesses. Furthermore, a correspondence relation between the physical extent and the logical extent of the extents which constitute the logical volume is held only in the storage device 12 in which the corresponding physical extent is present.

In response to processing request commands other than media access-based instructions including write and read instructions of processing requests sent from the host device 18, for example, control commands such as an SCSI's Inquiry command, Read Capacity command, and Report LUNs command, the storage device 12 to which the host device 18 has accessed sends a processing result to the host device 18.

Next, a flow of the processing by the storage cluster system according to the present embodiment constituted as described above will be described with reference to a flow chart shown in FIG. 9.

A processing request command is sent from the host device 18 to the storage cluster, and then the processing request command is received by the storage device 12 (#A) (S21).

In a case where this processing request command is any other than the media access-based commands (NO at S22), the storage device 12 (#A) performs the processing, and sends a result of the processing to the host device 18 as a response (S23).

On the other hand, in a case where this processing request command is a media access-based command (YES at S22), the processing is performed as described in the first or second embodiment, and finally a result of the processing is sent to the host device 18 (S24).

In consequence, if the processing request command is any other than the media access-based commands, it is possible to realize efficient transmission without passing through useless routing.

### Sixth Embodiment

The present invention is described below with reference to the sixth embodiment.

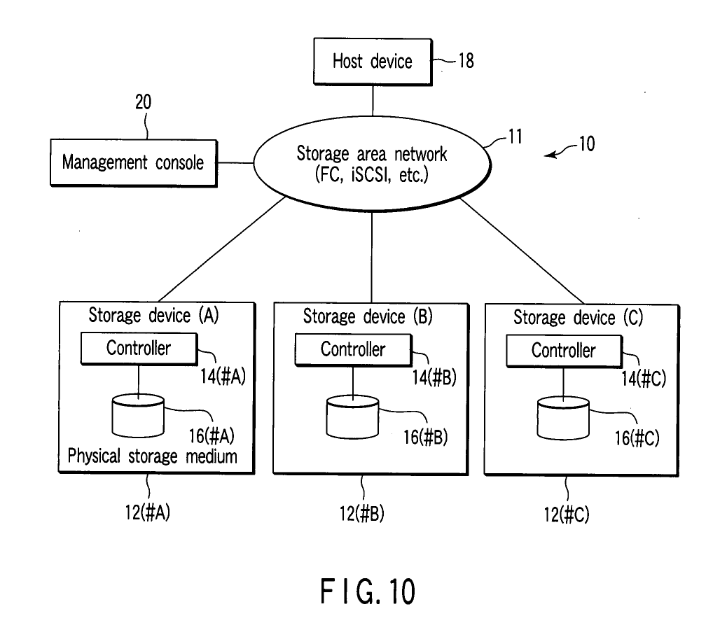

A storage cluster system which applies the data processing method according to the sixth embodiment of the present invention is a modification of a storage cluster system which applies the data processing method according to the first or second embodiment. As shown in FIG. 10 or 11, the storage cluster system which applies the data processing method according to the first or second embodiment further includes a management console 20. This management console 20 constructs a default prioritized routing table. Therefore, only the management console 20 will be described below, and repetitive explanations will be omitted.

FIG. 10 is a block diagram showing a configuration example in which a storage area network 11 is provided with the management console 20, and FIG. 11 is a block diagram showing another configuration example in which the storage devices 12 (#A, B#, and #C) are connected to each other by a LAN22 and the LAN22 is provided with the management console 20.

The management console 20 transmits information of the storage devices 12 (#A, B#, and #C) and a construction request of the storage cluster to an arbitrary storage device 12 of the storage devices 12 (#A, B#, and #C). The storage device 12 of a transmission destination is defined as a construction master which plays a role of a master for construction processing of the storage cluster. Hereinafter, the storage device 12 (#A) will be described as the construction master.

The storage device 12 (#A), which is the construction master, transmits a test message to the storage devices 12 (#B) and 12 (#C).

Then, the storage devices 12 (#B) and 12 (#C) receive the test message, and returns responses to the test message to the storage device 12 (#A), which is the construction master.

The storage device 12 (#A) which is the construction master measures response times of the storage devices 12 (#B and #C) to the test message based on the responses returned from the storage devices 12 (#B and #C), prioritizes the storage devices 12 (#B and #C) from a short side of the response times to thereby determine an access priority order and to create the default prioritized routing table, and transmits a list of the storage devices 12 (#A, #B, and #C) included in the storage cluster to each of the storage devices 12 (#B and #C).

In accordance with the returned list, the storage devices 12 (#B and #C) other than the construction master transmit a test message to the other storage devices. For example, the storage device 12 (#B) transmits the test message, to the storage device 12 (#A) and the storage device 12 (#C), and the storage device 12 (#C) transmits the test message to the storage devices 12 (#A) and the storage device 12 (#B). On the other hand, each storage device 12, when having received the test message, returns a response to the test message to the storage device 12 of the transmission source.

The storage devices 12 (#B and #C) other than the construction master measure response times of the storage devices 12 to the test message based on the thus returned responses, prioritize the storage devices 12 from a short side of the response times to thereby determine an access priority order and to create the default prioritized routing table, and transmit an construction completion response of the access priority order to the storage device 12 (#A) which is the construction master.

The storage device 12 (#A), which is the construction master, when having received the construction completion response, returns the construction completion response of the access priority order to the management console 20, to perform construction processing of the storage cluster.

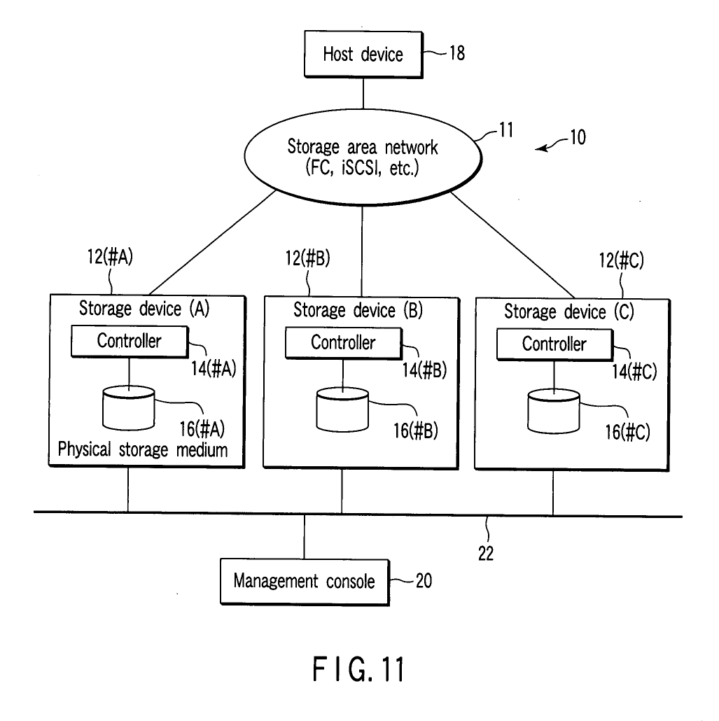

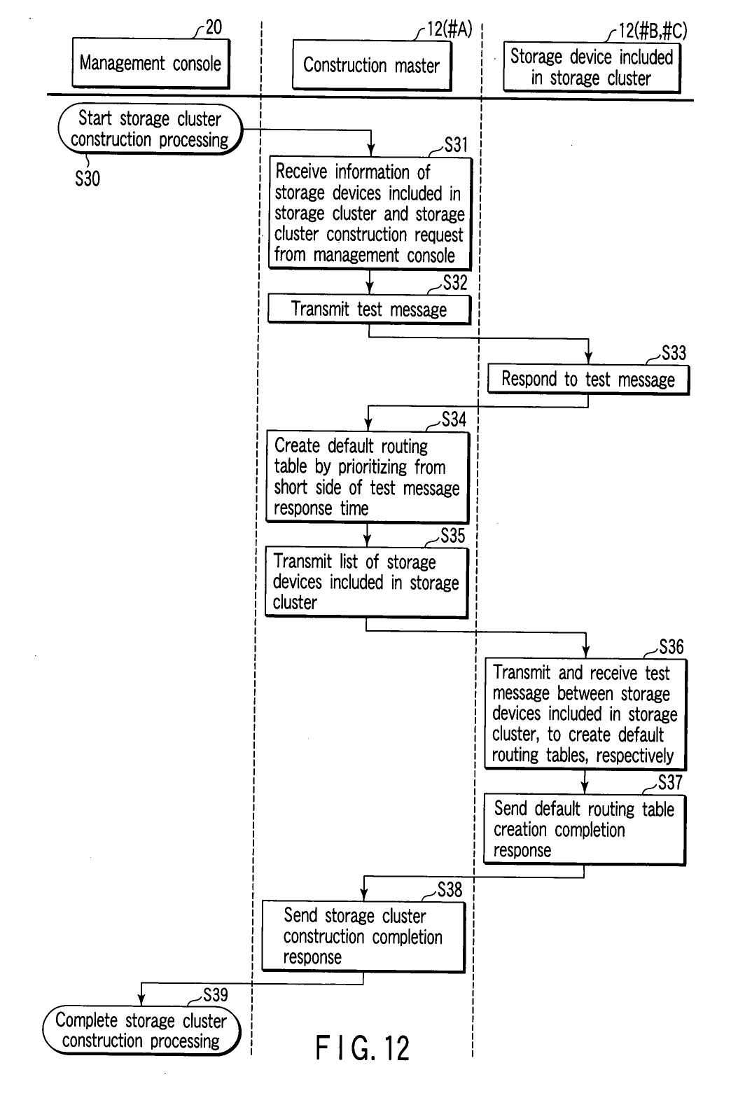

Next, a flow of the above construction processing of the storage cluster will be described below with reference to a flow chart shown in FIG. 12.

When the construction processing of the storage cluster starts (S30), the management console 20 transmits information of the storage devices 12 (#A, #B, and #C) and a construction request of the storage cluster to an arbitrary storage device 12 (here, the storage device 12 (#A)) of the storage devices 12 (#A, #B, and #C). The storage device 12 (#A) of the transmission destination is defined as the construction master, which plays a role of a master for the construction processing of the storage cluster (S31).

Then, from the storage device 12 (#A) which is the construction master, a test message is transmitted to the storage device 12 (#B) and the storage device 12 (#C) (S32).

When this test message is received by the storage devices 12 (#B and #C), the storage devices 12 (#B and #C) create responses to the test message, and the create responses are returned to the storage device 12 (#A) which is the construction master (S33).

The storage device 12 (#A) which is the construction master measures response times of the storage devices 12 (#B and #C) to the test message based on the responses returned from the storage devices 12 (#B and #C), and prioritizes the storage devices 12 (#B and #C) from a short side of the response times to thereby determine an access priority order and to create a default prioritized routing table (S34). Furthermore, a list of the storage devices 12 (#A, #B, and #C) included in the storage cluster is transmitted to the storage devices 12 (#B and #C) (S35).

In accordance with the transmitted list, from the storage devices 12 (#B and #C) other than the construction master transmits, a test message is transmitted to the storage devices 12 other than the above storage devices. Each of the storage devices 12 which have received the test message returns a response to the test message to the transmission source storage devices 12. The storage devices 12 (#B and #C) other than the construction master measure response times of the storage devices 12 to the test message based on the returned responses, and prioritize the storage devices 12 from a short side of the response times to thereby determine an access priority order and to create a prioritized routing table (S36). Then, from the storage devices 12 (#B and #C) other than the construction master, a creation completion response of the prioritized routing table is returned to the storage device 12 (#A), which is the construction master to notify the storage device 12 (#A) of the construction completion of the access priority order (S37).

Then, after the completion response has been received by the storage device 12 (#A), which is the construction master, the construction completion response of the access priority order is returned from the storage device 12 (#A) which is the construction master to the management console 20 (S38), whereby the construction processing of the storage cluster is completed (S39).

The storage cluster system according to the present embodiment makes it possible to efficiently construct the prioritized routing table as described above.

### Seventh Embodiment

The present invention will be described below with reference to the seventh embodiment.

A storage cluster system which applies a data processing method according to the seventh embodiment of the present invention is a modification of the storage cluster system which applies the data processing method according to the sixth embodiment. In this modification, the management console 20 performs addition processing for adding a new storage device 12 to the storage cluster which is operating. Therefore, the management console 20 which performs the addition processing will be described below, and repetitive explanations will be omitted.

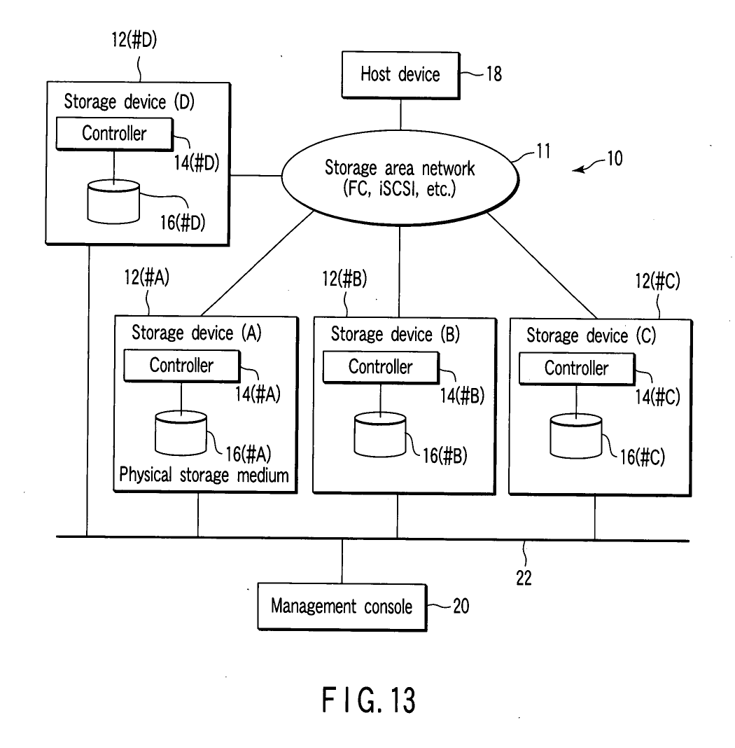

As shown in FIG. 13, for example, the management console 20 performs addition processing in a case were a new storage device 12 (#D) is added to the storage cluster which is operating. FIG. 13 shows a configuration example in which the management console 20 is connected to a LAN22 connected to the storage devices 12 (#A, #B, #C, and #D), but the management console 20 may be connected to a storage area network 11, for example, as shown in FIG. 10.

In the case of adding the new storage device 12 (#D) to the storage cluster which is operating, the management console 20 transmits a request for addition of the new storage device 12 (#D) and information of the new storage device 12 (#D) to an arbitrary storage device (which is here the storage device 12 (#A) tentatively) of the storage devices 12 (#A, #B, and #C) which is now operating. The storage device 12 (#A) of a transmission destination is defined as a master of addition which plays a role of a master for procedure for addition of the storage device 12 (#D). Hereinafter, description will be made under the assumption that the storage device 12 (#A) is the master of addition.

The storage device 12 (#A), which is the master of addition transmits a test message to the new storage devices 12 (#D). When the test message is transmitted thereto in this manner, the storage device 12 (#D) responds to the storage device 12 (#A) which is the master of addition.

After the storage device 12 (#A), which is the master of addition has confirmed the reception of the response, an access priority order of the storage device 12 (#D) is added to a prioritized routing table as the lowest access priority position. Furthermore, the storage device 12 (#A) transmits a message about the addition of the new storage device 12 (#D) to the storage cluster and information of the new storage device 12 (#D) to the storage devices 12 (#B and #C) in which the access priority order has already been defined in the prioritized routing table.

The storage devices 12 other than the storage device 12 (#A) as the master of addition and the new storage device 12 (#D), that is, the storage device 12 (#B) and the storage device 12 (#C) add the new storage device 12 (#D) at the lowest priority position in their prioritized routing tables, respectively, and return an addition completion response to the master of addition.

Next, the storage device 12 (#A), which is the master of addition transmits a list of the storage devices included in the storage cluster to the new storage device 12 (#D). In accordance with this list, the new storage device 12 (#D) transmits a test message to the storage devices 12 other than the storage device 12 (#D), that is, the storage device 12 (#A), the storage device 12 (#B) and the storage device 12 (#C).

The storage devices 12 (#A, #B, and #C) receive the test message, and return a response to the test message to the new storage device 12 (#D).

The new storage device 12 (#D) measures response times of the storage devices 12 (#A, #B, and #C) to the test message based on the responses sent back, and prioritizes the storage devices 12 (#A, #B, and #C) from a short side of the response times to thereby determine an access priority order, thus creating a prioritized routing table. Then, the new storage device 12 (#D) returns a prioritized routing table creation completion response to the storage device 12 (#A), which is the master of addition.

The storage device 12 (#A) which is the master of addition receives the addition completion response from the storage devices 12 (#B and #C) and creates completion response from the storage device 12 (#D), and then returns a response of the addition completion of the new storage device 12 (#D) to the management console 20, thereby completing the procedure for addition of the new storage device 12 (#D).

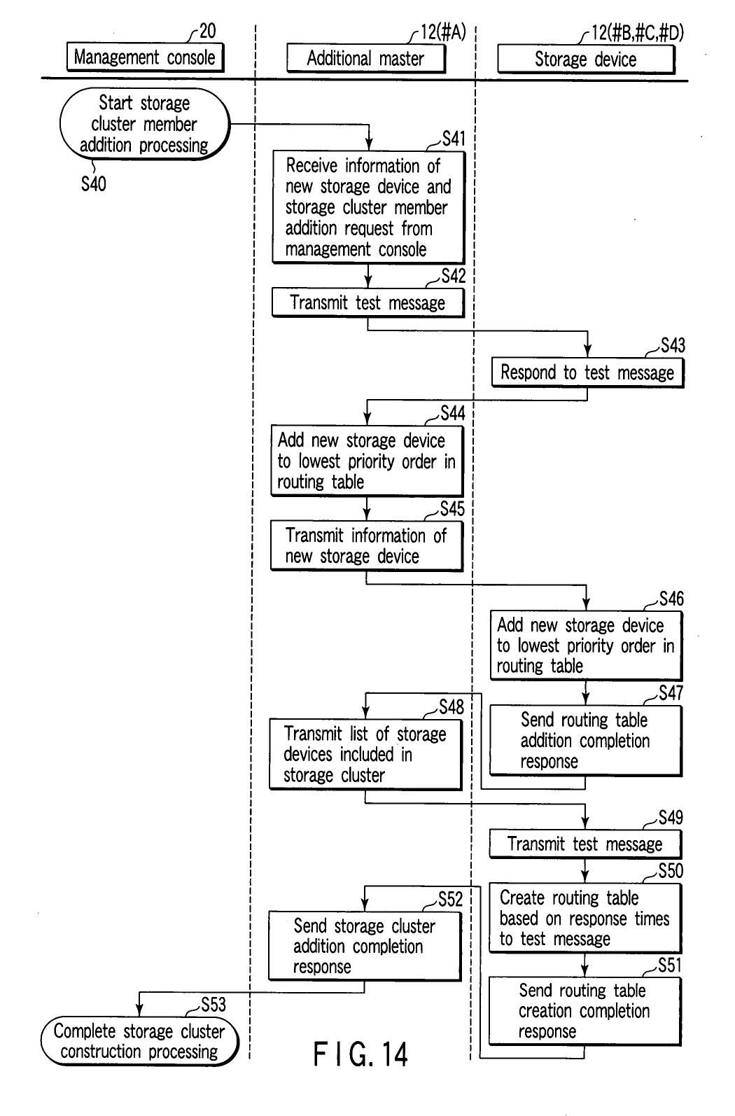

Next, a flow of the procedure for addition of the new storage device to the above storage cluster will be described with reference to a flow chart shown in FIG. 14. Hereinafter, the description will be made under the assumption that the storage device 12 (#A) is the master of addition.

In the case of adding the new storage device 12 (#D) to the storage cluster which is operating, the management console 20 transmits a request for addition of the new storage device 12 (#D) and information of the new storage device 12 (#D) to an arbitrary storage device (here, the storage device 12 (#A)) of the storage devices 12 (#A, #B, and #C) which is now operating (S40). In accordance with the fact that the transmitted addition request and information are received by the storage device 12 (#A), the storage device 12 (#A) is defined as the master of addition which plays a role of a master for the procedure for addition of the storage device 12 (#D) (S41).

The storage device 12 (#A) defined as the master of addition transmits a test message to the new storage devices 12 (#D) (S42).

After the thus transmitted test message has been received by the storage device 12 (#D), the storage device 12 (#D) responds to the storage device 12 (#A), which is the master of addition (S43).

After this response has been received and confirmed by the storage device 12 (#A), which is the master of addition, the storage device 12 (#A) adds an access priority order of the storage device 12 (#D) to the prioritized routing table as the lowest priority order (S44). Furthermore, the storage device 12 (#A) transmits a message about the addition of the storage device 12 (#D) to the storage cluster and information of the new storage device 12 (#D) to the storage device 12 (#B and #C) in which the access priority order has already been defined in the prioritized routing table (S45).

In each of the storage device 12 (#A), the storage device 12 (#B) and the storage device 12 (#C), the new storage device 12 (#D) is added at the lowest priority position in the prioritized routing table (S46). Afterward, the storage device 12 (#B) and the storage device 12 (#C) return the addition completion response to the storage device 12 (#A), which is the master of addition (S47).

Next, the storage device 12 (#A), which is the master of addition, transmits a list of the storage devices included in the storage cluster to the new storage device 12 (#D) (S48).

On the other hand, the new storage device 12 (#D) transmits a test message to the storage devices 12 other than the new storage device 12 (#D), that is, the storage device 12 (#A), the storage device 12 (#B) and the storage device 12 (#C) (S49) in accordance with the above list. After having received the test message, the storage devices 12 (#A, #B, and #C) return a response to the test message to the new storage device 12 (#D).

The storage device 12 (#D) measures response times of the storage devices 12 (#A, #B, and #C) to this test message based on the responses sent back, and prioritizes the storage devices 12 (#A, #B, and #C) from a short side of the response times to thereby determine an access priority order, thus creating a prioritized routing table (S50). Then, the storage device 12 (#D) returns a prioritized routing table creation completion response to the storage device 12 (#A) which is the master of addition (S51).

When having received the creation completion response from the storage device 12 (#D), the storage device 12 (#A), which is the master of addition, returns an addition completion response of the new storage device 12 (#D) to the management console 20 (S52). Accordingly, the procedure for addition of the new storage device 12 (#D) is completed (S53).

The storage cluster system according to the present embodiment enables the efficient addition of the new storage device 12 (#D) in such a manner as described above.

### EXAMPLES

The following will further describe specific examples of the storage cluster systems described in the first to seventh embodiments.

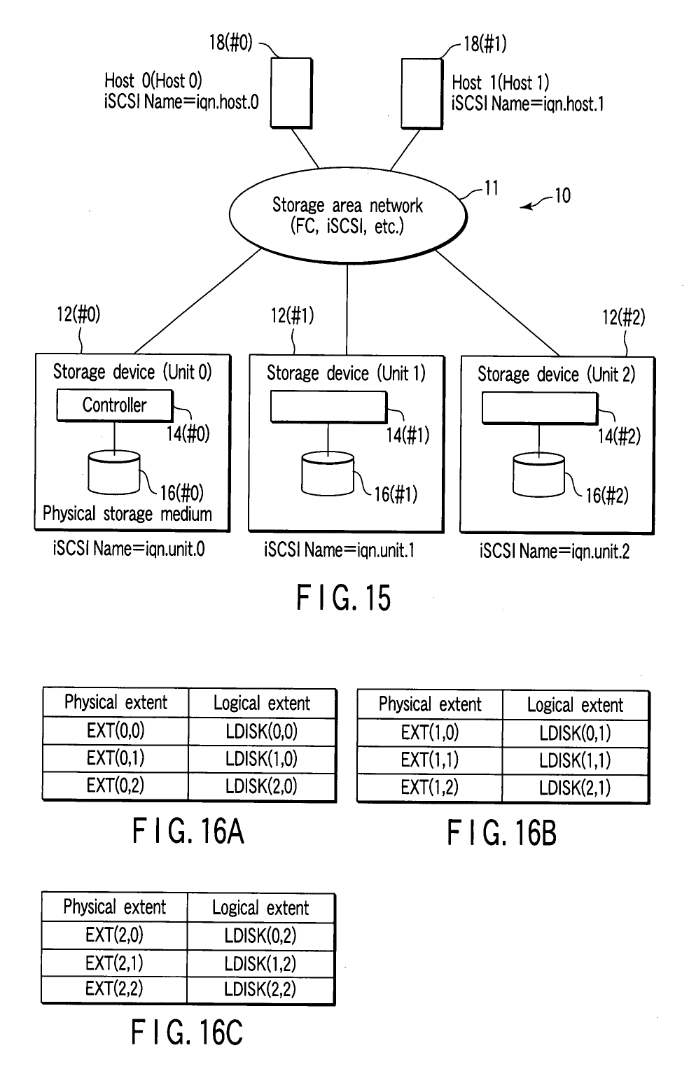

First, further specific examples in the first, second and fifth embodiments will be described below by using the storage cluster system 10 having such a configuration as shown in FIG. 15.

The storage devices 12 (#0, #1, and #2) which constitute the storage cluster system 10 of FIG. 15 have the physical storage media 16 (#0, #1, and #2), respectively, as shown FIG. 2. Each of the physical storage media 16 (#0, #1, and #2) has three extents EXTs (#0, #1, and #2) having a size of 1 GB, and therefore each physical storage media 16 (#0, #1, and #2) has a total capacity of 3 GB. The storage cluster of the configuration example shown in FIG. 15 has the three storage devices 12, and hence a total capacity of the whole storage cluster is 9 GB.

On the other hand, a correspondence relation between each logical extent LDISK and each physical extent EXT is defined by a table shown in FIG. 16. The table of FIG. 16A is held in the storage device 12 (#0), the table of FIG. 16B is held in the storage device 12 (#1), and the table of FIG. 16C is held in the storage device 12 (#2).

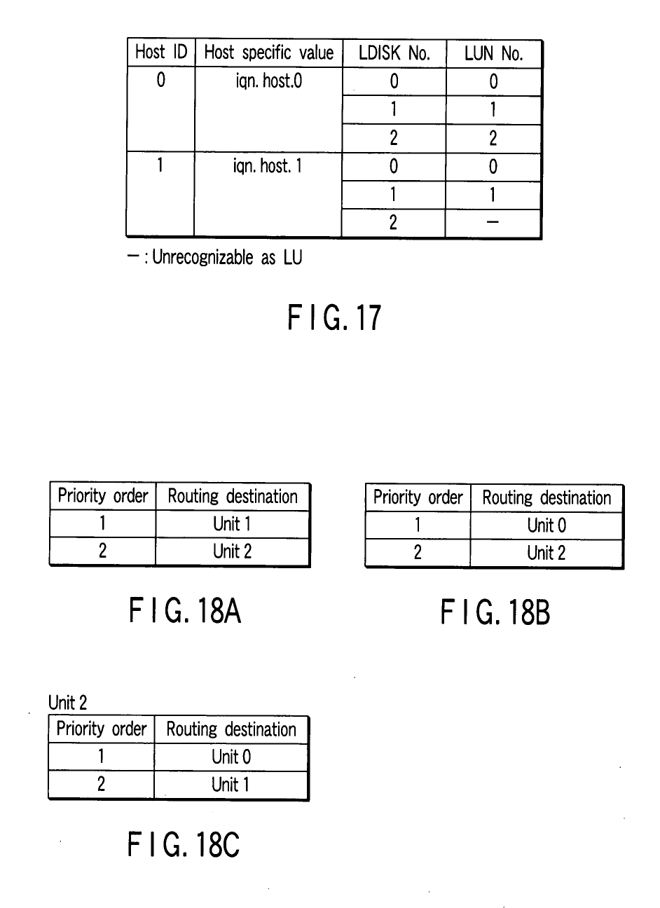

Further, as shown in FIG. 17, the storage devices 12 (#0, #1, and #2) have in common a host device-LUN mapping table which shows a relation among an identification number (Host ID) of the host device 18, a specific value (see FIG. 15) of the host device 18, a logical extent LDISK number, and an LUN number.

The storage device 12 (#0) holds the prioritized routing table which is created as described in the sixth embodiment and shown in, for example, FIG. 18A. Similarly, the storage device 12 (#1) holds such a prioritized routing table as shown in FIG. 18B, and the storage device 12 (#2) holds such a prioritized routing table as shown in FIG. 18C.

Next, a flow of read processing is described below in a case where a processing request sent from the host device 18 (#0) to the storage device 12 (#0) is such a read request command A as given below.

Command A:
SCSI Command Code=28h (READ EXTENDED)
LUN=02h
LBA=400001h (≧2 GB, <3 GB)
Transfer Size=100h (128 KB)

Flow of Processing:

1) The host device 18 (#0) transmits the command A to the storage device 12 (#0).

2) The storage device 12 (#0) specifies Host ID=0 based on a request of the command A to decide whether the command A is access to a logical volume accessible from the host device 18 (#0). In this case, the storage device 12 (#0) first specifies an access logical extent LDISK in the command A. In this case, the storage device 12 (#0) refers to a mapping table of FIG. 17 to decide that the command A is access to a logical extent LDISK2 and is accessible.

3) Next, the storage device 12 (#0) decides which logical extent LDISK the command A is access to. It is decided which logical extent on the logical extent LDISK from an LBA of the command A1, but in this case, on the basis of 2 GB≦LBA<3 GB, the storage device 12 (#0) decides that the command A is the access to the physical extent EXT (#2). Therefore, in consideration of a result of the above step 2), the storage device 12 (#0) decides that the command A is the access to the logical extent LDISK (2, 2).

4) The storage device 12 (#0) decides whether a physical extent corresponding to the logical extent LDISK (2, 2) is present in the storage device 12 (#0) itself. In this case, the storage device 12 (#0) refers to the table shown in FIG. 16A to decide that the logical extent (2, 2) is not present in the physical storage medium 16 (#0) of the storage device 12 (#0).

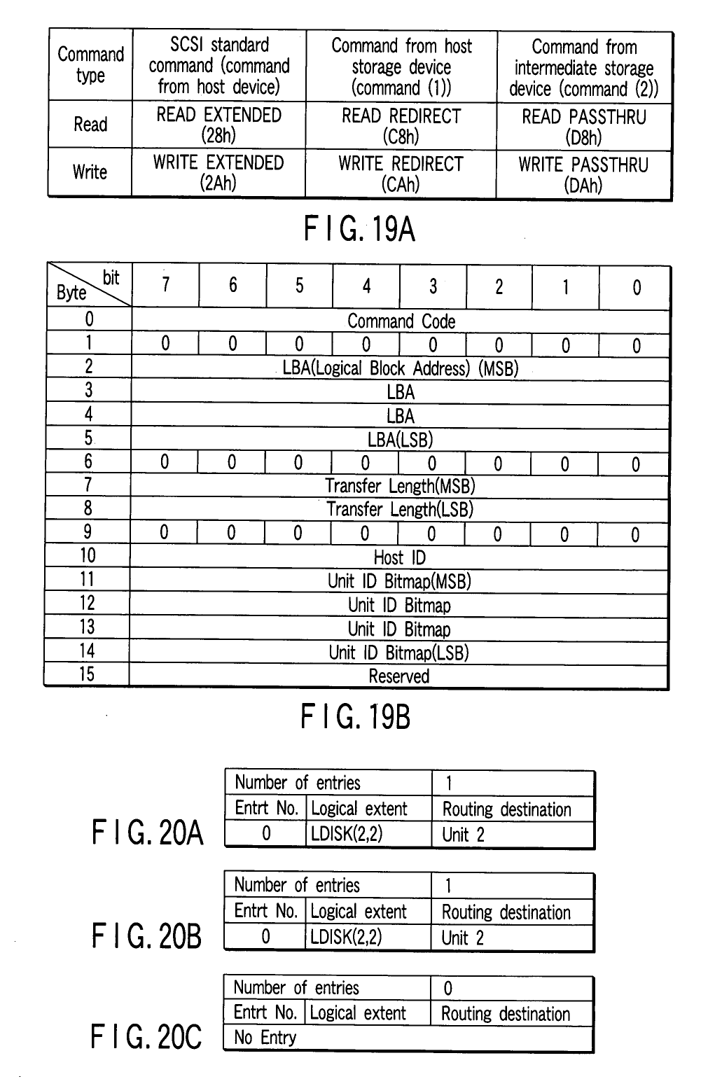

5) Since the command A is not the access to the physical storage medium 16 (#0) in the storage device 12 (#0), the storage device 12 (#0) transfers the request to the storage device of the highest priority order except the upstream storage device as defined by the prioritized routing table of FIG. 18A, that is, the storage device 12 (#1). At this time, the request is transmitted in the form of a vendor-unique command such as shown in the following command B as the vendor-unique command in the second embodiment. It is to be noted that FIG. 19A is a table in which the SCSI commands for read and write are summarized for each device of a transmission source, and FIG. 19B is a table showing one example of a command format.

Command B (Transfer from the storage device 12 (#0) to the storage device 12 (#1):
SCSI Command Code=C8h (READ REDIRECT)
LUN=02h
LBA=400001h (≧2 GB, <3 GB)
Transfer Size=100h (128 KB)
Host ID=00h
Unit ID Bitmap|=0X01 (set Bit 0) (→Host ID Bitmap=0X01)

6) The storage device 12 (#1) receives the command B, and decides the command B is access to the logical extent LDISK (2, 2) in consideration of a combination of the Host ID and LUN contained in the command B as in the above steps 2) to 4) and further decides whether the corresponding physical extent EXT is present in the physical storage medium 16 (#1) in the storage device 12 (#1). In this case, the storage device 12 (#1) refers to the table shown in FIG. 16B to decide that the logical extent LDISK (2, 2) is not present in the physical storage medium 16 (#1) of the storage device 12 (#0).

7) Since the command A is not the access to the physical storage medium 16 (#1) in the storage device 12 (#1), the storage device 12 (#1) transfers the request to the storage device 12 (#2) which is the storage device of the highest priority order except the upstream storage device present in Host 1 ID Bitmap in the prioritized routing table shown in FIG. 18B. At this time, the command A is transmitted in the form of a such vendor-unique command as shown in the following command C as such a vendor-unique command as shown in the following command C as the vendor-unique command in the second embodiment.

Command C (Transfer from the storage device 12 (#1) to the storage device 12 (#2):
SCSI Command Code=D8h (READ PASSTHRU)(vendor-unique)
LUN=02h
LBA=400001h (≧2 GB, <3 GB)
Transfer Size=100h (128 KB)
Host ID=00h
Unit ID Bitmap|=0X02 (set Bit 0) (→Host ID Bitmap=0X03)

8) The storage device 12 (#2) receives the command C, and decides the command B is access to the logical extent LDISK (2, 2) in consideration of a combination of the Host ID and LUN contained in the command C as in the above steps 2) to 4) and further decides whether the corresponding physical extent EXT is present in the physical storage medium 16 (#2) in the storage device 12 (#1). In this case, the storage device 12 (#2) refers to the table shown in FIG. 16C to decide that the logical extent LDISK (2, 2) is present in the physical storage medium 16 (#2) of the storage device 12 (#2) and corresponds the physical extent EXT (2, 2).

9) The storage device 12 (#2) decides that the command C is transferred from the intermediate storage device 12 (#1) by a command code of the command C. That is, it is decided that the command sent from the host device 18 (#0) to the storage device 12 (#0) is transferred via the storage device 12 (#1).

10) As described in the second embodiment, the storage device 12 (#2) returns such a sense data as shown in the following response A to the storage device 12 (#1) which is a transmission source of the command C.

Response A
SCSI Status=Check Condition (02h)
Sense Key=Not Direct Transfer (C0h) (Vendor-Unique)
Sense Date=Host ID of Storage device 12 (02h) (#2)
11) The response A is transferred in a reverse order of the case of the command, i.e., in the order of the storage device 12 (#2)→the storage device 12 (#1)→the storage device 12 (#0). As shown in FIGS. 20A and 20B, when the access acquires an extent routing table to the corresponding logical extent LDISK (2, 2), the storage device 12 (#1) and the storage device 12 (#2) learn to directly transmit the response A to storage device 12 (#2) in a case where the access to the same logical extent LDISK (2, 2) is next received.

12) After having received the response A, the storage device 12 (#0) which is a host transmits the following command D to the storage device 12 (#2) on the basis of the extent routing table (FIG. 20A) learned in the above step 11).

Command D:
SCSI=Command Code=C8h (READ REDIRECT)
LUN=02h
LBA=400001h (≧2 GB, <3 GB)
Transfer Size=100h (128 KB)
Host ID=00h
Unit ID Bitmap|=0x01 (set Bit 0) (→Host ID Bitmap=0x01)

13) The storage device 12 (#2) receives the command D, and decides that the command D is access to the logical extent LDISK (2, 2) in the same manner as in the steps 2) to 4) and further decides whether the corresponding physical extent EXT is present in the physical storage medium 16 (#2) of the storage device 12 (#2). In this case, the storage device 12 (#2) refers to the table shown in FIG. 16C to decide that the logical extent LDISK (2, 2) is present in the physical storage medium 16 (#2) of the storage device 12 (#2) and corresponds the physical extent EXT (2, 2).

14) The storage device 12 (#2) decides that the command D is transferred from the storage device, i.e., the storage device 12 (#2) in accordance with the command code of the command D.

15) The storage device 12 (#2) performs read access to the physical extent EXT (2, 2) to transfer a series of data between the storage device 12 (#0) and the storage device 12 (#2).

16) After the completion of the read transfer between the storage device 12 (#0) and the storage device 12 (#2), the storage device 12 (#0) performs the read transfer to the host device 18 (#0), whereby the processing is completed.

In consequence, it is possible to avoid an increase in routing information in proportion to the number of the storage devices 12 included in the storage cluster, which suppresses an increase in a table search time and an increase in a storage region for table holding. In addition, a configuration at the time of migration of the extents can be automatically changed, if necessary. As a result, efficient routing can be realized.

The best modes to perform the present invention have been described above with reference to the accompanying drawings, but the present invention is not limited to the configurations of the modes. In a technical category of the inventions in the claims, a person skilled in the art can contrive various changes and modifications. Therefore, it can be understood that these changes and modifications are to be in the technical range of the present invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A storage cluster system which includes a storage cluster constituted of a plurality of storage devices, and a host device connected to the storage cluster by a first communication network,
each storage device comprising:
a plurality of accessible regions into which a region logically accessible by the host device is divided;
a controller to access to physically accessible regions of the plurality of accessible regions which are physically managed by the storage device; and
priority order information which is referred to by the controller and which defines an access priority order of the storage device including the controller to the other storage devices;
wherein the controllers in the respective storage devices are connected to each other by a second communication network, whereby each of the storage devices accesses to the physically accessible region in any of the other storage devices via the controller,
when a processing request for the physically accessible region not present in the storage device is sent from the host device, the controller in the storage device sends the processing request to the controller in the other storage device of the highest priority order except the storage device to which the processing request has already been sent, in accordance with the priority order defined in the priority order information,
when a processing request for the physically accessible region present in the storage device is sent from the host device, the controller in the storage device performs the processing in response to the processing request and sends a result of the processing to a delivery source of the processing request,
when the processing result is sent from the controller in the other storage device to the storage device, the controller in the storage device sends the processing result to the delivery source which has sent the processing request corresponding to the processing result to the storage device, the processing result is sent to the storage device which has received the processing request from the host device, and this storage device sends the received processing result to the host device.

2. A storage cluster system including a storage cluster constituted of a plurality of storage devices, and a host device connected to the storage cluster by a first communication network,
each storage device comprising:
a plurality of accessible regions into which a region logically accessible by the host device is divided;
a controller to access to a physically accessible region of the plurality of accessible regions which is physically managed by the storage device; and
priority order information which is referred to by the controller and which defines an access priority order of the storage device including the controller to the other storage devices;
wherein the controllers in the respective storage devices are connected to each other by a second communication network, whereby each of the storage devices accesses to the physically accessible region in any of the other storage devices via the controller,
the storage device which has received from the host device a processing request for the physically accessible region not present in the storage device acquires from the processing request a unique specific command corresponding to the processing request, introduces bit map data including an identifier of the storage device and an identifier of the host device into the command code, sets a bit at a bit position corresponding to the identifier of the storage device in bit map data, and sends the command code to any of the other storage devices of the highest priority order except the storage device to which the processing request has already been sent, in accordance with the priority order information,
in a case where, in the storage device to which the command code is sent from any of the plurality of storage devices, the processing request corresponding to the command code is a processing request for the physically accessible region not present in the storage device, the storage device sets a bit at a bit position corresponding to the identifier in the bit map data included in the command code, and sends the command code to the storage device of the highest priority order except the storage device to which the processing request has already been sent, in accordance with the priority order information,
in a case where the processing request corresponding to the sent command code is a processing request for the physically accessible region present in the storage device and in a case where the bit map data is not included in the sent command code,
this storage device performs the processing in response to the processing request corresponding to the command code and sends a result of the processing to the host device,
in a case where the bit map data is included in the sent command code and a bit is set at any one of the bit positions, this storage device performs the processing in response to the processing request corresponding to the command code, and sends a result of the processing to the storage device having the identifier corresponding to the bit position where the bit is set,
in a case where the bit map data is included in the sent command code and the bits are set at a plurality of bit positions, this storage device performs the processing in response to the processing request corresponding to the command code, creates a response for the storage device which has received the processing request directly from the host device, and sends the created response to the storage device which has received the processing request from the host device via the storage device having the identifier corresponding to the bit position where the bit is set,
the storage device to which the response is sent requests the storage device which has created the response to send the processing result,
the requested storage device sends the processing result to the storage device of a request source, so that the processing result obtained in any one of the storage devices is sent to the storage device which has received the processing request directly from the host device, and
the storage device which has received the processing request directly from the host device sends the processing result to the host device.

3. The storage cluster system according to claim 1 or 2, wherein
in a case where the processing request is sent to the controller in the other storage device in accordance with the priority order defined in the priority order information and in a case where the controller of a destination does not accept the processing request and in a case where an error response is returned from the controller or in a case where the controller gives no response for a predetermined lapse of time, the processing request is sent to the controller in the storage device of the next highest priority order except the storage device to which the processing request has already been sent.

4. The storage cluster system according to claim 1 or 2, wherein
the storage device of the plurality of storage devices to which the host device has accessed is equipped with a notification part which notifies the host device of information of a physically accessible region held in each of the storage devices, and
the host device is equipped with a switch part which switches the storage device to which the processing request is to be sent, on the basis of the information notified from the notification part and contents of the processing request.

5. The storage cluster system according to claim 1 or 2, wherein
every storage device in the storage cluster includes a data table which manages a combination of capacity information of a logical volume which is constituted of one or a combination of two or more of the plurality of accessible regions included in each storage device and which is recognized by the host device, a host identification number which specifies the host device permitted to access to the logical volume, and a physically accessible region identification number to specify a physically accessible region to which the host device accesses,
the storage device only in which the physically accessible region is present holds a correspondence relation between the physically accessible region and the logically accessible region which is recognized by the host device, among the accessible regions which constitute the logical volume, and
the storage device to which the host device has accessed sends the processing result to the host device, in response to a processing request other than media access commands including write and read commands, among the processing requests sent from the host device.

6. The storage cluster system according to claim 1 or 2, which further includes a management console which manages the storage cluster,
wherein the management console sends information of the storage devices and a construction request of the storage cluster to an arbitrary one of the storage devices, and the storage device of the destination is defined as a construction master which plays a role of a master of construct processing of the storage cluster,
the construction master transmits a test message to each storage device corresponding to the information sent from the management console,
each storage device which has received the test massage returns a response to the test message to the construction master,
the construction master measures response times of the storage devices to the test message based on the responses returned from the storage devices, prioritizes the storage devices from a short side of the response times to thereby create priority order information, and sends a list of the storage devices included in the storage cluster to each of the storage devices,
each of the storage devices other than the construction master transmit the test message to the storage devices other than the storage device in accordance with the sent list,
each storage device which has received the test message returns a response to the test message to the storage device of the transmission source,
the storage devices other than the construction master measure response times of the storage devices to the test message based on the returned responses, prioritizes the storage devices from a short side of the response times to thereby create priority order information, returns a construction completion response for the priority order information to the construction master, and
the construction master, when having received the construction completion response, returns the construction completion response for the priority order information to the management console to perform construction processing of the storage cluster.

7. The storage cluster system according to claim 1 or 2, which further includes a management console which performs procedure for addition to add a new storage device to the storage cluster which is operating,
wherein the management console transmits a request for addition of the new storage device and information of the new storage device to an arbitrary one of the storage devices, and the storage device of a transmission destination is defined as a master of addition which plays a role of a master of the procedure for addition of the storage device,
the master of addition transmits a test message to the new storage device to which the information has been transmitted from the management console, confirms a response sent by the new storage device to the transmitted test message, adds an access priority order of the new storage device to the priority order information as the lowest priority order, and transmits a message about the addition of the new storage device to the storage cluster and the information of the new storage device to the storage devices in which the access priority order has already been defined in the priority order information,
the storage devices other than the master of addition and the new storage device add the new storage device to the lowest position in the priority order information of the storage devices, and return an addition completion response to the master of addition,
the master of addition transmits a list of the storage devices included in the storage cluster to the new storage device,
the new storage device transmits a test message to the storage devices other than the storage device in accordance with the list,
the storage devices which have received the test message return a response to the test message to the new storage device,
the new storage device measures response times of the storage devices to the test message based on the returned responses, and prioritizes the storage devices from a short side of the response times to thereby create priority order information, and returns a construction completion response for the priority order information to the master of addition, and
the master of addition, when having received the construction completion response and the addition completion response, returns an addition completion response for the new storage device to the management console, thereby completing the procedure for addition of the new storage device.

8. A data processing method which is applied to a storage cluster system including a storage cluster constituted of a plurality of storage devices, and a host device connected to the storage cluster by a first communication network,
each storage device comprising:
a plurality of accessible regions into which a region logically accessible by the host device is divided;
a controller to access to physically accessible regions of the plurality of accessible regions which are physically managed by the storage device; and
priority order information which is referred to by the controller and which defines an access priority order of the storage device including the controller to the other storage devices;
wherein the controllers in the respective storage devices are connected to each other by a second communication network, whereby each of the storage devices accesses to the physically accessible region in any of the other storage devices via the controller,
when a processing request for the physically accessible region not present in the storage device is sent from the host device, the controller in the storage device sends the processing request to the controller in the other storage device of the highest priority order except the storage device to which the processing request has already been sent, in accordance with the priority order defined in the priority order information,
when a processing request for the physically accessible region present in the storage device is sent from the host device, the controller in the storage device performs the processing in response to the processing request and sends a result of the processing to a delivery source of the processing request,
when the processing result is sent from the controller in the other storage device to the storage device, the controller in the storage device sends the processing result to the delivery source which has sent the processing request corresponding to the processing result to the storage device, the processing result is sent to the storage device which has received the processing request from the host device, and this storage device sends the received processing result to the host device.

9. A data processing method which is applied to a storage cluster system including a storage cluster constituted of a plurality of storage devices, and a host device connected to the storage cluster by a first communication network,
each storage device comprising:
a plurality of accessible regions into which a region logically accessible by the host device is divided;
a controller to access to a physically accessible region of the plurality of accessible regions which is physically managed by the storage device; and
priority order information which is referred to by the controller and which defines an access priority order of the storage device including the controller to the other storage devices;
wherein the controllers in the respective storage devices are connected to each other by a second communication network, whereby each of the storage devices accesses to the physically accessible region in any of the other storage devices via the controller,
the storage device which has received from the host device a processing request for the physically accessible region not present in the storage device acquires from the processing request a unique specific command corresponding to the processing request, introduces bit map data including an identifier of the storage device and an identifier of the host device into the command code, sets a bit at a bit position corresponding to the identifier of the storage device in bit map data, and sends the command code to any of the other storage devices of the highest priority order except the storage device to which the processing request has already been sent, in accordance with the priority order information,
in a case where, in the storage device to which the command code is sent from any of the plurality of storage devices, the processing request corresponding to the command code is a processing request for the physically accessible region not present in the storage device, the storage device sets a bit at a bit position corresponding to the identifier in the bit map data included in the command code, and sends the command code to the storage device of the highest priority order except the storage device to which the processing request has already been sent, in accordance with the priority order information,
in a case where the processing request corresponding to the sent command code is a processing request for the physically accessible region present in the storage device and in a case where the bit map data is not included in the sent command code, this storage device performs the processing in response to the processing request corresponding to the command code and sends a result of the processing to the host device,
in a case where the bit map data is included in the sent command code and a bit is set at any one of the bit positions, this storage device performs the processing in response to the processing request corresponding to the command code, and sends a result of the processing to the storage device having the identifier corresponding to the bit position where the bit is set,
in a case where the bit map data is included in the sent command code and the bits are set at a plurality of bit positions, this storage device performs the processing in response to the processing request corresponding to the command code, creates a response for the storage device which has received the processing request directly from the host device, and sends the created response to the storage device which has received the processing request from the host device via the storage device having the identifier corresponding to the bit position where the bit is set,
the storage device to which the response is sent requests the storage device which has created the response to send the processing result,
the requested storage device sends the processing result to the storage device of a request source, so that the processing result obtained in any one of the storage devices is sent to the storage device which has received the processing request directly from the host device, and
the storage device which has received the processing request directly from the host device sends the processing result to the host device.

10. The data processing method according to claim 8 or 9, wherein
in a case where the processing request is sent to the controller in the other storage device in accordance with the priority order defined in the priority order information and in a case where the controller of a destination does not accept the processing request and in a case where an error response is returned from the controller or in a case where the controller gives no response for a predetermined lapse of time, the processing request is sent to the controller in the storage device of the next highest priority order except the storage device to which the processing request has already been sent.

11. The data processing method according to claim 8 or 9, wherein
the storage device of the plurality of storage devices to which the host device has accessed notifies the host device of information of a physically accessible region held in each of the storage devices, and
the host device switches the storage device to which the processing request is to be sent, on the basis of the notified information and contents of the processing request.

12. The data processing method according to claim 8 or 9, wherein
every storage device in the storage cluster includes a data table which manages a combination of capacity information of a logical volume which is constituted of one or a combination of two or more of the plurality of accessible regions included in each storage device and which is recognized by the host device, a host identification number which specifies the host device permitted to access to the logical volume, and a physically accessible region identification number to specify a physically accessible region to which the host device accesses,
the storage device only in which the physically accessible region is present holds a correspondence relation between the physically accessible region and the logically accessible region which is recognized by the host device, among the accessible regions which constitute the logical volume, and
the storage device to which the host device has accessed sends the processing result to the host device, in response to a processing request other than media access commands including write and read commands, among the processing requests sent from the host device.

13. The data processing method according to claim 8 or 9,
wherein the storage cluster system further includes a management console which manages the storage cluster,
the management console sends information of the storage devices and a construction request of the storage cluster to an arbitrary one of the storage devices, and the storage device of the destination is defined as a construction master which plays a role of a master of construct processing of the storage cluster,
the construction master transmits a test message to each storage device corresponding to the information sent from the management console,
each storage device which has received the test massage returns a response to the test message to the construction master,
the construction master measures response times of the storage devices to the test message based on the responses returned from the storage devices, prioritizes the storage devices from a short side of the response times to thereby create priority order information, and sends a list of the storage devices included in the storage cluster to each of the storage devices,
each of the storage devices other than the construction master transmit the test message to the storage devices other than the storage device in accordance with the sent list,
each storage device which has received the test message returns a response to the test message to the storage device of the transmission source,
the storage devices other than the construction master measure response times of the storage devices to the test message based on the returned responses, prioritizes the storage devices from a short side of the response times to thereby create priority order information, returns a construction completion response for the priority order information to the construction master, and
the construction master, when having received the construction completion response, returns the construction completion response for the priority order information to the management console to perform construction processing of the storage cluster.

14. The data processing method according to claim 8 or 9,
wherein the storage cluster system further includes a management console which performs procedure for addition to add a new storage device to the storage cluster which is operating,
the management console transmits a request for addition of the new storage device and information of the new storage device to an arbitrary one of the storage devices, and the storage device of a transmission destination is defined as a master of addition which plays a role of a master of the procedure for addition of the storage device,
the master of addition transmits a test message to the new storage device to which the information has been transmitted from the management console, confirms a response sent by the new storage device to the transmitted test message, adds an access priority order of the new storage device to the priority order information as the lowest priority order, and transmits a message about the addition of the new storage device to the storage cluster and the information of the new storage device to the storage devices in which the access priority order has already been defined in the priority order information,
the storage devices other than the master of addition and the new storage device add the new storage device to the lowest position in the priority order information of the storage devices, and return an addition completion response to the master of addition,
the master of addition transmits a list of the storage devices included in the storage cluster to the new storage device,
the new storage device transmits a test message to the storage devices other than the storage device in accordance with the list,
the storage devices which have received the test message return a response to the test message to the new storage device,
the new storage device measures response times of the storage devices to the test message based on the returned responses, and prioritizes the storage devices from a short side of the response times to thereby create priority order information, and returns a construction completion response for the priority order information to the master of addition, and
the master of addition, when having received the construction completion response and the addition completion response, returns an addition completion response for the new storage device to the management console, thereby completing the procedure for addition of the new storage device.

15. A program which is applied to a storage cluster system including a storage cluster constituted of a plurality of storage devices, and a host device connected to the storage cluster by a first communication network,
each storage device comprising a plurality of accessible regions into which a region logically accessible by the host device is divided, a controller to access to physically accessible regions of the plurality of accessible regions which are physically managed by the storage device, and priority order information which is referred to by the controller and which defines an access priority order of the storage device including the controller to the other storage devices, the controllers in the respective storage devices being connected to each other by a second communication network,
the program allowing a computer to realize:
a function that each of the storage devices accesses to the physically accessible region in any of the other storage devices via the controller,
a function that when a processing request for the physically accessible region not present in the storage device is sent from the host device, the controller in the storage device sends the processing request to the controller in the other storage device of the highest priority order except the storage device to which the processing request has already been sent, in accordance with the priority order defined in the priority order information,
a function that when a processing request for the physically accessible region present in the storage device is sent from the host device, the controller in the storage device performs the processing in response to the processing request and sends a result of the processing to a delivery source of the processing request,
a function that when the processing result is sent from the controller in the other storage device to the storage device, the controller in the storage device sends the processing result to the delivery source which has sent the processing request corresponding to the processing result to the storage device, the processing result is sent to the storage device which has received the processing request from the host device, and
a function that the storage device which has received this processing result sends this processing request to the host device.

16. A program which is applied to a storage cluster system including a storage cluster system including a storage cluster constituted of a plurality of storage devices, and a host device connected to the storage cluster by a first communication network,
each storage device including a plurality of accessible regions into which a region logically accessible by the host device is divided, a controller to access to a physically accessible region of the plurality of accessible regions which is physically managed by the storage device, and priority order information which is referred to by the controller and which defines an access priority order of the storage device including the controller to the other storage devices, the controllers in the respective storage devices being connected to each other by a second communication network,
the program allowing a computer to realize:
a function that each of the storage devices accesses to the physically accessible region in any of the other storage devices via the controller,
a function that the storage device which has received from the host device a processing request for the physically accessible region not present in the storage device acquires from the processing request a unique specific command corresponding to the processing request, introduces bit map data including an identifier of the storage device and an identifier of the host device into the command code, sets a bit at a bit position corresponding to the identifier of the storage device in bit map data, and sends the command code to any of the other storage devices of the highest priority order except the storage device to which the processing request has already been sent, in accordance with the priority order information,
a function that, in a case where, in the storage device to which the command code is sent from any of the plurality of storage devices, the processing request corresponding to the command code is a processing request for the physically accessible region not present in the storage device, the storage device sets a bit at a bit position corresponding to the identifier in the bit map data included in the command code, and sends the command code to the storage device of the highest priority order except the storage device to which the processing request has already been sent, in accordance with the priority order information,
a function that, in a case where the processing request corresponding to the sent command code is a processing request for the physically accessible region present in the storage device and in a case where the bit map data is not included in the sent command code, this storage device performs the processing in response to the processing request corresponding to the command code and sends a result of the processing to the host device,
a function that, in a case where the processing request corresponding to the sent command code is a processing request for the physically accessible region present in the storage device and in a case where the bit map data is included in the sent command code and a bit is set at any one of the bit positions, this storage device performs the processing in response to the processing request corresponding to the command code, and sends a result of the processing to the storage device having the identifier corresponding to the bit position where the bit is set,
a function that, in a case where the processing request corresponding to the sent command code is a processing request for the physically accessible region present in the storage device and in a case where the bit map data is included in the sent command code and the bits are set at a plurality of bit positions, this storage device performs the processing in response to the processing request corresponding to the command code, creates a response for the storage device which has received the processing request directly from the host device, and sends the created response to the storage device which has received the processing request from the host device via the storage device having the identifier corresponding to the bit position where the bit is set,
a function that the storage device to which the response is sent requests the storage device which has created the response to send the processing result,
a function that the requested storage device sends the processing result to the storage device of a request source, so that the processing result obtained in any one of the storage devices is sent to the storage device which has received the processing request directly from the host device, and
a function that the storage device which has received the processing request directly from the host device sends the processing result to the host device.

17. The program according to claim 15 or 16 which allows a computer to further realize:
a function that, in a case where the processing request is sent to the controller in the other storage device in accordance with the priority order defined in the priority order information and in a case where the controller of a destination does not accept the processing request and in a case where an error response is returned from the controller or in a case where the controller gives no response for a predetermined lapse of time, the processing request is sent to the controller in the storage device of the next highest priority order except the storage device to which the processing request has already been sent.

18. The program according to claim 15 or 16 which allows a computer to further realize:
a function that the storage device of the plurality of storage devices to which the host device has accessed notifies the host device of information of a physically accessible region held in each of the storage devices, and
a function that the host device switches the storage device to which the processing request is to be sent, on the basis of the notified information and contents of the processing request.

19. The program according to claim 15 or 16, wherein
every storage device in the storage cluster includes a data table which manages a combination of capacity information of a logical volume which is constituted of one or a combination of two or more of the plurality of accessible regions included in each storage device and which is recognized by the host device, a host identification number which specifies the host device permitted to access to the logical volume, and a physically accessible region identification number to specify a physically accessible region to which the host device accesses, and
the storage device only in which the physically accessible region is present holds a correspondence relation between the physically accessible region and the logically accessible region which is recognized by the host device, among the accessible regions which constitute the logical volume,
the program allowing a computer to further realize:
a function that the storage device to which the host device has accessed sends the processing result to the host device, in response to a processing request other than media access commands including write and read commands, among the processing requests sent from the host device.

20. The program according to claim 15 or 16 wherein the storage cluster system further includes a management console which manages the storage cluster,
the program allowing a computer to further realize:
a function that the management console sends information of the storage devices and a construction request of the storage cluster to an arbitrary one of the storage devices, and the storage device of the destination is defined as a construction master which plays a role of a master of construct processing of the storage cluster,
a function that the construction master transmits a test message to each storage device corresponding to the information sent from the management console,
a function that each storage device which has received the test massage returns a response to the test message to the construction master,
a function that the construction master measures response times of the storage devices to the test message based on the responses returned from the storage devices, prioritizes the storage devices from a short side of the response times to thereby create priority order information, and sends a list of the storage devices included in the storage cluster to each of the storage devices,
a function that each of the storage devices other than the construction master transmit the test message to the storage devices other than the storage device in accordance with the sent list,
a function that each storage device which has received the test message returns a response to the test message to the storage device of the transmission source,
a function that the storage devices other than the construction master measure response times of the storage devices to the test message based on the returned responses, prioritizes the storage devices from a short side of the response times to thereby create priority order information, returns a construction completion response for the priority order information to the construction master, and
a function that the construction master, when having received the construction completion response, returns the construction completion response for the priority order information to the management console to perform construction processing of the storage cluster.

21. The program according to claim 15 or 16
wherein the storage cluster system further includes a management console which performs procedure for addition to add a new storage device to the storage cluster which is operating,
the program allowing a computer to further realize:
a function that the management console transmits a request for addition of the new storage device and information of the new storage device to an arbitrary one of the storage devices, and the storage device of a transmission destination is defined as a master of addition which plays a role of a master of the procedure for addition of the storage device,
a function that the master of addition transmits a test message to the new storage device to which the information has been transmitted from the management console, confirms a response sent by the new storage device to the transmitted test message, adds an access priority order of the new storage device to the priority order information as the lowest priority order, and transmits a message about the addition of the new storage device to the storage cluster and the information of the new storage device to the storage devices in which the access priority order has already been defined in the priority order information,
a function that the storage devices other than the master of addition and the new storage device add the new storage device to the lowest position in the priority order information of the storage devices, and return an addition completion response to the master of addition,
a function that the master of addition transmits a list of the storage devices included in the storage cluster to the new storage device,
a function that the new storage device transmits a test message to the storage devices other than the storage device in accordance with the list,
a function that the storage devices which have received the test message return a response to the test message to the new storage device,
a function that the new storage device measures response times of the storage devices to the test message based on the returned responses, and prioritizes the storage devices from a short side of the response times to thereby create priority order information, and returns a construction completion response for the priority order information to the master of addition, and
a function that the master of addition, when having received the construction completion response and the addition completion response, returns an addition completion response for the new storage device to the management console, thereby completing the procedure for addition of the new storage device.
